(19) United States
(12) Patent Application Publication
(10) Pub. No.: US 2014/0099571 A1
(43) Pub. Date: Apr. 10, 2014

(54) CATALYSTS MADE USING THERMALLY DECOMPOSABLE POROUS SUPPORTS

(71) Applicant: Institut National de la Recherche Scientifique, Quebec City (CA)

(72) Inventors: Eric PROIETTI, Montreal (CA); Michel LEFEVRE, Sainte-Julie (CA); Frederic JAOUEN, Le Havre (FR); Jean-Pol DODELET, Sainte-Julie (CA)

(73) Assignee: Institut National de la Recherche Scientifique, Quebec City (CA)

(21) Appl. No.: 13/958,301

(22) Filed: Aug. 2, 2013

Related U.S. Application Data
(63) Continuation of application No. PCT/IB2012/000371, filed on Feb. 8, 2012.
(60) Provisional application No. 61/440,663, filed on Feb. 8, 2011.

(51) Int. Cl. H01M 4/90

(52) U.S. Cl. CPC H01M 4/9083
USPC 429/527; 502/182; 502/185

(57) ABSTRACT

A catalyst precursor is provided having a thermally decomposable porous support; an organic coating/filling compound, and a non-precious metal precursor, wherein the organic coating/filling compound and the non-precious metal catalyst precursor coat and/or fill the pores of the thermally decomposable porous support.

### CROSS-REFERENCE TO RELATED APPLICATIONS

This application is continuation application of co-pending International Application No. PCT/2012/000371 filed Feb. 8, 2012, which claims the benefit under 35 U.S.C. §119(e) of U.S. Provisional Patent Application Ser. No. 61/440,663, filed on Feb. 8, 2011, entitled CATALYSTS MADE USING THERMALLY DECOMPOSABLE POROUS SUPPORTS, which are incorporated by reference herein in their entirety.

### BACKGROUND

The subject matter of this disclosure relates to catalyst precursors, catalysts, and methods of producing these catalyst precursors and catalysts. More specifically, the present invention is concerned with non-precious metal catalysts. Such materials can be used for oxygen reduction reactions in fuel cells, including acid or alkaline polymer electrolyte membrane fuel cells, microbial fuel cells and metal-air batteries.

Polymer electrolyte membrane fuel cells (PEMFC's) are one of today's promising power generation alternatives to the internal combustion engine and rechargeable batteries. Their advantages include zero point-of-use emissions, which is especially attractive for automotive propulsion. Moreover, unlike rechargeable batteries, PEM fuel cell systems allow vehicles to be refueled quickly and offer driving ranges comparable to conventional gasoline engine vehicles. While this technology has matured significantly over the past decades, the high cost of PEM fuel cell systems is still a major impediment for their widespread commercial use, particularly for automotive propulsion.

Due to the rather low operating temperature of PEMFCs (ca. 80° C.), catalysts play an essential role in boosting the reaction kinetics to produce the desired high power densities. It is widely accepted that the platinum-based catalysts, used in the cathode in current PEM fuel cells are one of the key contributors to the high cost of these systems. According to numerous studies on mass production cost of PEMFC systems submitted to the U.S. DOE Annual Merit Review and independent studies over the last 5 years, Pt-based electrodes alone account for roughly half the cost of the PEMFC stack. The two approaches for addressing this issue are to either lower platinum loading while maintaining high power and durability performance or replace platinum-based electrocatalysts altogether with a well-performing lower-cost alternative, such as non-precious transition metal-based electrocatalysts, for example.

Recent efforts in PEM fuel cell research have been in the development of low-cost non-precious metal catalysts (NPMC). In order to obtain a non-precious metal catalyst for oxygen reduction in fuel cells, a carbon support (that is not thermally decomposable in an inert atmosphere), a nitrogen source and a non-precious metal precursor (NPMP) are typically used.

One approach in the synthesis of NPMCs has been to use a nitrogen source such a ammonia, an organic compound, an iron- or cobalt-based compound and a carbon support (that is not thermally decomposable in an inert atmosphere). The catalysts are obtained by impregnation of a porous carbon black support (that is not thermally decomposable in an inert atmosphere) with an iron precursor like iron(II) acetate (FeAc) and a nitrogen source, followed by pyrolysis, in an inert or reactive atmosphere. Major improvements to the overall performance of these low-cost non-precious metal catalysts (NPMC) for the oxygen reduction reaction in polymer electrolyte membrane fuel cells are necessary if they are to replace the expensive platinum-based catalysts currently used. One of the toughest challenges for NPMCs is achieving higher power density at efficient fuel cell voltages, such as 0.6V or higher, for example.

### SUMMARY

Catalysts made using thermally decomposable porous support (TDPS) and method of their manufacture are described. Catalyst precursor compositions and their manufacture are also described.

In one aspect, a catalyst precursor includes a thermally decomposable porous support; and organic coating/filling compound; a non-precious metal precursor, wherein the organic coating/filling compound and the non-precious metal catalyst precursor coat and/or fill the pores of the thermally decomposable porous support.

In one or more embodiments, the at least one of the thermally decomposable porous support, the non-precious metal precursor or the organic coating/filling compound includes nitrogen.

In any of the preceding embodiments, the thermally decomposable porous support is microporous and is one or more supports selected from the group consisting of metal-organic-frameworks, covalent-organic-frameworks, polymer-organic-frameworks, microporous organic polymers, polymers of intrinsic microporosity and a microporous polymers.

In any of the preceding embodiments, the metal organic framework includes a zeolitic imidazolate framework, and for example, the zeolitic imidazolate framework includes ZIF-8.

In any of the preceding embodiments, the metal of the zeolitic imidazolate framework includes zinc.

In any of the preceding embodiments, the thermally decomposable porous support includes a metal organic framework and the metal is one or more selected from the group consisting of zinc, cobalt, manganese, magnesium, iron, copper, aluminum and chromium.

In any of the preceding embodiments, the thermally decomposable porous support has a total surface area of greater than 500 m²/g, or the thermally decomposable porous support has a total surface area of greater than 1000 m²/g, or the thermally decomposable porous support has a total surface area of greater than 1500 m²/g.

In any of the preceding embodiments, the thermally decomposable porous support is one that loses between 20% and 90% of its mass in an inert atmosphere at a temperature in the range of 100° C. to 1200° C., or the thermally decomposable porous support is one that loses at least 50% of its mass in an inert atmosphere at a temperature in the range of 100° C. to 1200° C.

In any of the preceding embodiments, the non-precious metal precursor is a precursor of iron or cobalt.

In any of the preceding embodiments, the catalyst has an iron loading of about 0.2 wt % to about 5 wt % or more based on the total weight of the catalyst precursor, or an iron loading of about 1-2 wt % based on the total weight of the catalyst precursor.

In any of the preceding embodiments, the non-precious metal precursor is a salt of a non-precious metal or an organometallic complex of a non-precious metal, and for example, the non-precious metal precursor is Fe(II) acetate.

In any of the preceding embodiments, the non-precious metal precursor and the organic coating/filling compound are the same molecule.

In any of the preceding embodiments, the organic coating/filling compound includes a poly-aromatic structure.

In any of the preceding embodiments, the organic coating/filling compound is selected from the group consisting of perylene-tetracarboxylic-dianhydride, 1,10-phenanthroline, perylene tetracarboxylic-diimide, and polypyrrole or polyaniline and mixtures thereof.

In any of the preceding embodiments, the mass ratio of organic coating/filling compound to thermally decomposable porous support is about 95:5 to about 5:95.

In another aspect, a catalyst is prepared by pyrolysing the catalyst precursor as described above, wherein the catalyst precursor has been pyrolysed so that the micropore surface area of the catalyst is substantially larger than the micropore surface area of catalyst precursor, with the proviso that the pyrolysis is performed in the presence of a gas that is a nitrogen precursor when the thermally decomposable porous support, the non-precious metal precursor and the organic coating/filling compound are not nitrogen precursors.

In one or more embodiments, the pyrolysis temperature is between 300° C. and 1200° C., or the pyrolysis temperature is at least 700° C.

In any of the preceding embodiments, the mass loss during pyrolysis is greater than 50%, or the mass loss during pyrolysis is greater than 80%.

In another aspect, a catalyst includes a microporous carbon support and having a carbon content of at least 80 wt % and a total surface area of at least 500 m²/g; and a non-precious metal at a loading of at least 0.2 wt %, wherein the non-precious metal-ion is in contact with the microporous support through a pyridinic or pyrrolic-type structure forming the catalytic sites, wherein the catalyst when incorporated into a membrane electrode assembly demonstrates a volumetric activity of greater than 100 A/cm³ at an iR-free cell voltage of 0.8V.

In any of the preceding embodiments, the catalyst has a nitrogen content of about 0.5 wt % or more based on the total weight of the catalyst.

In any of the preceding embodiments, the catalyst is an oxygen reduction catalyst, a catalyst for the electroreduction of hydrogen peroxide, a catalyst for the disproportionation of hydrogen peroxide or a catalyst for the reduction of CO₂.

In another aspect, a method for producing a catalyst precursor, the method includes providing one or more thermally decomposable porous supports; one or more non-precious metal precursors; and optionally one or more organic coating/filling compounds; and coating and/or filling the micropores of the thermally decomposable porous support with the optional organic coating/filling compound and the non-precious metal precursor so that the surface area of the catalyst precursor is substantially smaller than the surface area of the thermally decomposable porous support when the organic coating/filling compound and the non-precious metal precursor are absent.

In one or more embodiments, the method further provides pyrolysing the catalyst precursor so that the micropore surface area of the catalyst is substantially larger than the micropore surface area of the catalyst precursor, with the proviso that the pyrolysis is performed in the presence of a gas that is a nitrogen precursor when the thermally decomposable porous support, the non-precious metal precursor and the organic coating/filling compound are not nitrogen precursors.

In any of the preceding embodiments, the method has a pyrolysis temperature between 300° C. and 1200° C., or the pyrolysis temperature is at least 700° C.

In any of the preceding embodiments, the method has a mass loss during pyrolysis is greater than 50%, or the mass loss during pyrolysis is greater than 80%.

In any of the preceding embodiments, the thermally decomposable porous support loses between 20% and 90% of its mass during pyrolysis.

In any of the preceding embodiments, the non-precious metal precursor includes iron or cobalt.

### BRIEF DESCRIPTION OF THE DRAWING

The invention is described with reference to the following drawings, which are presented by way of illustration only and are not intended to be limiting of the invention.

FIG. 1 is a schematic diagram illustrating a method for preparing a catalyst precursor according to one or more embodiments.

FIG. 2 is a schematic diagram illustrating a method of pyrolysing a catalyst precursor to obtain an electrocatalyst composition according to one or more embodiments.

FIG. 3 is a graph illustrating the polarization curves (filled symbols) and power density curves (hollow symbols) for membrane electrode assemblies (MEAs) with a cathodes made using a catalyst according to one or more embodiments of the invention (stars) or a non-precious metal catalyst (NPMC) prepared using a carbon black support (circles), as well as for a commercial platinum-based MEA (Gore 5510 PREMEA, squares) for reference.

FIG. 4 is a graph illustrating the Tafel plot in terms of volumetric current density (expressed in A cm⁻³) of a catalyst according to one or more embodiments (stars) and a non-precious metal catalyst (NPMC) prepared using a carbon black support (circles). All Tafel curves were converted to U.S. DOE reference conditions: 1 bar absolute pressure for H₂ and O₂, 80° C. fuel cell temperature and 100% RH, 0.8 V iR-free cell voltage. The volumetric activity at 0.8V iR-free requires an extrapolation of the Tafel slope and is the intersection of this linear extrapolation and the 0.8V iR-free axis. The 2010 and 2015 U.S. DOE targets for volumetric activity of non-Pt catalysts at U.S. DOE reference conditions are also shown (large circle and large star, respectively).

FIG. 5 is a set of Scanning Electron Microscope (SEM) images illustrating the structure and morphology of a non-precious metal catalyst (NPMC) prepared using a carbon black support (A and B) and a catalyst according to one or more embodiments of the invention (C and D).

FIG. 6 is a summary of selected data (Tafel plots, X-ray diffractograms, XPS N1s narrow scan spectra and TEM images) corresponding to a thermally decomposable porous support (ZIF-8 (A and B), a catalyst precursor prepared using ZIF-8(C and D).

FIG. 7 is a graph illustrating the polarization curves and Tafel plots (insert) of MEAs with cathodes made using catalysts according to one or more embodiments of the invention. The organic coating/filling compound (OCFC) and thermally decomposable porous support (TDPS) used for all catalysts were 1,10-phenanthroline and ZIF-8, respectively. The OCFC/TDPS mass ratio in the catalyst precursor was 20/80 for all catalysts. The non-precious metal precursor (NPMP) was ferrous acetate (FeAc) and the nominal iron loading in the catalyst precursors was 1 wt % for all catalysts. All catalysts were first pyrolysed in argon gas at 1050° C. for 60 minutes, then pyrolysed in ammonia gas at 950° C. for various durations as specified in the legend. All fuel cell tests were conducted under the same conditions: H₂/O₂, 80° C. fuel cell temperature, 15 psig back pressure at the anode and cathode sides, H₂ and O₂ gas flow rates of 0.3 slpm and 100% RH. The cathode catalyst loading used was ca. 1 mg cm⁻² and the ionomer-to-catalyst ratio was 1.5, the anode GDE was 0.5 mg_{Pt} cm⁻² 46 wt % Pt/C, and the polymer electrolyte membrane used was N117.

FIG. 8 is a graph illustrating the micropore surface area of catalysts shown in FIG. 7 vs. the duration of the pyrolysis in ammonia (2^{nd} pyrolysis) at 950° C.

FIG. 9 is a graph illustrating the polarization curves and Tafel plots (insert) of MEAs with cathodes made using catalysts according to one or more embodiments. The organic coating/filling compound (OCFC) and thermally decomposable porous support (TDPS) used for all catalysts was 1,10-phenanthroline and ZIF-8, respectively. The OCFC/TDPS mass ratio in the catalyst precursor was different for each catalyst and was as specified in the legend. The non-precious metal precursor (NPMP) was ferrous acetate (FeAc) and the nominal iron loading in the catalyst precursors was 1 wt % for all catalysts. All catalysts were first pyrolysed in argon gas at 1050° C. for 60 minutes, then pyrolysed in ammonia gas at 950° C. for various durations. For each OCFC/TDPS mass ratio only the catalyst with the highest catalytic activity is shown. All fuel cell tests were conducted under the same conditions: H₂/O₂, 80° C. fuel cell temperature, 15 psig back pressure at the anode and cathode sides, H₂ and O₂ gas flow rates of 0.3 slpm and 100% RH. The cathode catalyst loading used was ca. 1 mg cm⁻² and the ionomer-to-catalyst ratio was 1.5, the anode GDE was 0.5 mg_{Pt} cm⁻² 46 wt % Pt/C, and the polymer electrolyte membrane used was N117.

FIG. 10 is a graph illustrating the polarization curves of MEAs with cathodes made using catalysts according to one or more embodiments. The organic coating/filling compound (OCFC) and thermally decomposable porous support (TDPS) used for all catalysts was 1,10-phenanthroline and ZIF-8, respectively. The OCFC/TDPS mass ratio in the catalyst precursor was 20/80. The non-precious metal precursor (NPMP) was ferrous acetate (FeAc) and the nominal iron loading in the catalyst precursors was 1 wt % for all catalysts. All catalysts were first pyrolysed in argon gas at 1050° C. for 60 minutes, then pyrolysed in ammonia gas at 950° C. for 15 minutes. All fuel cell tests were conducted under the same conditions: H₂/O₂, 80° C. fuel cell temperature, 15 psig back pressure at the anode and cathode sides, H₂ and O₂ gas flow rates of 0.3 slpm and 100% RH. The cathode catalyst loading used was as specified in the legend and the ionomer-to-catalyst ratio was 1.5, the anode GDE was 0.5 mg_{Pt} cm⁻² 46 wt % Pt/C, and the polymer electrolyte membrane used was NRE211.

FIG. 11 is a graph illustrating the current density of MEAs with cathodes made using catalysts according to one or more embodiments over a period of 100 hours at 0.5 V cell voltage in H₂/O₂ and H₂/Air fuel cell test. The organic coating/filling compound (OCFC) and thermally decomposable porous support (TDPS) used for all catalysts was 1,10-phenanthroline and ZIF-8, respectively. The OCFC/TDPS mass ratio in the catalyst precursor was 20/80 for all catalysts. The non-precious metal precursor (NPMP) was ferrous acetate (FeAc) and the nominal iron loading in the catalyst precursors was 1 wt % for all catalysts. One catalyst was first pyrolysed in argon gas at 1050° C. for 60 minutes, then pyrolysed in ammonia gas at 950° C. for 15 minutes while another was only pyrolysed in argon gas at 1050° C. for 60 minutes (see legend). All fuel cell tests were conducted under the same conditions: H₂/O₂, 80° C. fuel cell temperature, 30 psig back pressure at the anode and cathode sides, H₂ and O₂ gas flow rates of 0.3 slpm and 100% RH. The cathode catalyst loading used was ca. 4 mg cm⁻² and the ionomer-to-catalyst ratio was 1.5, the anode GDE was 0.5 mg_{Pt} cm⁻² 46 wt % Pt/C, and the polymer electrolyte membrane used was N117.

FIG. 12 is a set of graphs illustrating the polarization curves of MEAs with cathodes made using catalysts according to one or more embodiments and selected data and information corresponding to the catalyst used and its synthesis method (OCFC, TDPS, OCFC/TDPS mass ratio in the catalyst precursor, NPMP, NPM content in the catalyst precursor, catalyst precursor mixing method, pyrolysis data and option treatment information). The thermally decomposable porous support (TDPS) used for all catalysts was ZIF-8. Fuel cell test conditions and MEA information are as specified in the respective graphs. The fuel cell temperature was 80° C. The gas flow rates were 0.3 slpm for all gases and 100% RH. The ionomer-to-catalyst ratio was 1.5 for all catalysts, the anode GDE was 0.5 mg_{Pt} cm⁻² 46 wt % Pt/C.

FIG. 13 is a set of Transmission Electron Microscope (TEM) images illustrating the structure of a non-precious metal catalyst (NPMC) prepared using a carbon black support (A) and a catalyst according to one or more embodiments (B).

FIGS. 14A-14D show the Tafel Plots, XRD, XDS N1s scans and TEM images, respectively, of catalyst precursor having a ZIF-8/1,10-phenanthroline/Fe mass ratio of 80/20/1 obtained after pyrolysis in argon gas for 60 minutes at (FIG. 14A) 400° C., (FIG. 14B) 700° C., (FIG. 14C) 850° C. and (FIG. 14D) 1050° C., respectively.

### DETAILED DESCRIPTION

### Definitions

As used herein a “catalyst” means a substance that initiates or facilitates a chemical or electrochemical reaction; a substance that boosts the kinetics of a given reaction.

A “catalyst precursor” is a substance from which a catalyst can be produced under appropriate processing conditions.

“Pyrolysis” means the transformation of a substance into one or more other substances by heat in the presence or absence of a gas (vacuum). Pyrolysis can occur in an inert gas (Ar or N₂ for example) or a reactive gas (NH₃, O₂, air, CO₂ or H₂ for example). Pyrolysis of organic substances produces gas and/or liquid products and leaves a solid residue richer in carbon content.

M/N/C-catalysts are electrocatalysts that include carbon (C), nitrogen (N) and a non-precious metal (M) that forms the center of the molecular catalytic site.

As used herein, a “non-precious metal” is a metal other than a precious metal. Precious metals are usually considered by the persons of skill in the art to be ruthenium, rhodium, palladium, osmium, iridium, platinum, and gold.

Porous materials are classified into several kinds by their size. According to IUPAC notation (see J. Rouquerol et al., Pure & Appl. Chem, 66 (1994) 1739-1758), microporous materials have pore diameters (or widths) of less than 2 nm, mesoporous materials have pore diameters (or widths) between 2 nm and 50 nm and macroporous materials have pore diameters (or widths) of greater than 50 nm.

### Electrocatalyst

In order for non-precious metal catalysts to compete with Pt-based catalysts for the oxygen reduction reaction in PEM fuel cells, they desirably possess one or more of the following three characteristics; (i) high volumetric activity, (ii) excellent mass transport properties and, (iii) high durability. Characteristics (i) and (ii) are relevant for achieving high power density.

The electrocatalyst suitable for use in oxygen reduction reactions contains a large number of catalytic sites on a microporous carbon support. The catalysts thus contain a high density of active sites. There may be different kinds of active sites in the same catalyst but all active sites for oxygen reduction are believed (without being bound by such interpretation) to include a carbon poly-aromatic structure, at least one non-precious metal ion and at least four nitrogen atoms. Without being bound by theory, it is believed that the nitrogen atoms are bound to the carbon atoms and/or to the metal ion(s), resulting in pyridinic-type or pyrrolic-type N atoms. It is also believed that the center of each active site is somewhat similar to the center of porphyrin or phthalocyanine molecules, for which all nitrogen atoms are of the pyrrolic-type. Finally, it is believed that the active sites have an electronic contact with the walls of the micropores. Such catalysts are referred to as a type of “M/N/C catalysts.”

In one or more embodiments, the microporous support is a support comprising micropores. For example, a microporous support may have a micropore surface area of more than about 100 m²/g. Herein, “micropores” refer to pores having a size of less than or equal to 2 nm (<2 nm). Most microporous supports usually also comprise mesopores (between 2 and 50 nm in size) and macropores (having a size>50 nm) and a total surface area of greater than 100 m²/g. As such, microporous supports have a “total” surface area, which is provided by the micropores, the mesopores and the macropores. As used herein the “micropore surface area” of a substance is the surface area of this substance provided by its micropores. The “total” surface area, e.g., micropore surface area, mesopore surface area and macropores surface area, can be determined by methods well known in the art. For example, by measuring the N₂-adsorption isotherm and analyzing it with the Brunauer Emett Teller (BET) equation and by applying quenched solid density functional theory using a slit-pore model (Quantachrome software) to determine pore size distribution.

In one or more embodiments, the microporous support is a highly microporous support. For example, a “highly microporous support” may be a microporous support having a micropore surface area of more than about 500 m² g, more than 750 m²/g, more than 1000 m²/g; more than 1100 m²/g and up to 2000 m²/g. M/N/C-catalysts have been prepared using carbon black supports (that are not thermally decomposable in an inert atmosphere). Carbon black based M/N/C-catalysts (such as those made with Black Pearls 2000) have a lower total surface area (750 m²/g vs. 1000 m²/g or higher) than the electrocatalysts described herein.

In one or more embodiments, the catalyst comprises up to about 10 wt % of the non-precious metal based on the total weight of the catalyst. In one or more embodiments, the catalyst has an iron loading of between about 0.2 wt % and about 5.0 wt %, or about 0.2 wt % or 1.0 or 5.0 or more based on the total weight of the M/N/C catalyst. In more specific embodiments, the M/N/C catalyst has an iron loading of about 3 wt % based on the total weight of the catalyst.

As noted above, the M/N/C catalyst includes a non-precious metal precursor (NPMP). It is to be understood that a mixture of non-precious metal can be used. Examples of the non-precious metals include metals having atomic numbers between 22 and 32, between 40 and 50 or between 72 and 82, with the exclusion of atomic numbers 44-47 and 75-79. In one or more embodiments, the non-precious metal is iron, cobalt, copper, chromium, manganese or nickel. In one or more embodiments, the non-precious metal is iron or cobalt.

The M/N/C catalyst may comprise between about 0.5 to about 10.0 wt % nitrogen based on the total weight of the catalyst. In embodiments, the catalyst has a nitrogen content, as provided by the nitrogen precursor, of about 0.5, 1.0, 2.0, 3.0, 4.0, 5.0, 6.0, 7.0, 8.0, or 9.0 wt % or more based on the total weight of the catalyst. This nitrogen content may be measured by methods known in the art, for example, x-ray photoelectron spectroscopy.

The disclosed M/N/C-catalysts show a catalytic activity in a fuel cell that is two or three times higher than that of the catalysts prepared using carbon black supports (that are not thermally decomposable in an inert atmosphere). With 276 A/cm³ (in at least one tested measured example), they surpass the target of 130 A/cm³ of volumetric activity set for year 2010 by the U.S. Department of Energy (U.S. DOE) and come much closer to the target of 300 A/cm³ set for year 2015. Moreover, and therein resides the main advantage of these novel non-precious-metal catalysts, the performance of these catalysts has been greatly improved at high current density, unlike the behavior observed for the catalysts prepared using carbon black supports (that are not thermally decomposable in an inert atmosphere). Stated differently, the power density has been increased substantially.

### Electrocatalyst Precursor

A precursor to the electrocatalyst and a method for its manufacture is also described. A catalyst precursor includes (i) a thermally decomposable porous support (TDPS); (ii) a non-precious metal precursor (NPMP); and (iii) an organic coating/filling compound (OCFC), optionally containing nitrogen, that coats and/or fills the pores of the TDPS.

A TDPS suitable for use in a catalyst precursor at least contains micropores, but may contain other pore sizes as well. A feature of the TDPS is that it contains a structure (framework or other) at the outset that is porous, but which can thermally decompose (with concomitant loss of mass) to provide a porous structure of enhanced carbon content. By way of example, the TDPS can have a mass loss of at least 20% and up to 90% in an inert atmosphere at temperatures between 300° C. and 1200° C. A TDPS can be pyrolyzed to a high carbon content structure of greater than about 60% by weight, or greater than 70% or 80% or 85% by weight carbon. In contrast, typical carbon blacks can have a maximum mass loss of up to about 5% in an inert atmosphere at temperatures between 300° C. and 1200° C. Significantly, the carbon black does not undergo significant, if any, changes or decomposition when heated up to temperatures of 1200° C. in an inert atmosphere. The mass loss experienced by typical carbon blacks is principally related to the removal of adsorbed water and small organic molecules. In comparison, significant mass loss in preparing the catalyst according to one or more embodiments causes changes in the catalyst precursor that can increase catalytic site density and create a catalyst morphology that provides better mass transport properties. Exemplary TDPSs include metal-organic-frameworks (MOFs), covalent-organic-frameworks (COFs), porous polymers or polymers of intrinsic microporosity (PIMs), hypercrosslinked polymers (HCP) or others. MOFs and COFs are sometimes referred to as coordination polymers or polymer-organic-frameworks (POFs).

Metal-organic frameworks (MOFs) are materials in which metal-to-organic ligand interactions yield porous coordination networks with record-setting surface areas surpassing activated carbons and zeolites. A characteristic of metal-organic frameworks (MOFs) is their high porosity (fraction of void volume to total volume) and high specific surface area. Typical total surface areas can range from 100 m²/g to 5000 m²/g. However, recent literature has reported surface areas of over 10000 m²/g. MOFs form three-dimensional crystal structures that support well-defined pores with internal diameters ranging from 0.1 to several nanometers. MOFs based on zinc, cobalt, manganese, magnesium, iron, copper, aluminum and chromium are known and can be used as TDPSs. Zeolitic imidazolate frameworks (ZIFs) prepared by copolymerization of either Zn(II) or Co(II) with imidazolate-type links are examples of suitable MOFs. The ZIF crystal structures are based on aluminosilicate zeolites, in which the tetrahedral Si(Al) and the bridging O are replaced with transition metal ion and imidazolate link, respectively. Exemplary MOFs include zinc imidazolate frameworks sold by BASF under the trade name Basolite, ZIF-1 to ZIF-12 and others (zinc- and cobalt-based MOF), and magnesium formate frameworks sold by Sigma Aldrich under the trade name Basosiv.

ZIF-derived catalysts resulted in significantly improved power performance. An exemplary ZIF has the trademark name Basolite™ Z1200 from BASF, with chemical formula ZnN₄CsH₁₂, that is commonly referred to in the literature as ZIF-8. ZIF-8 has a high BET surface area (1800 m² g⁻¹, and is almost entirely microporous), a pore size of 11.6 angstroms with openings to these pores of only 3.4 angstroms. Zinc, the metal in ZIF-8, is conveniently removed when the catalyst precursor containing ZIF-8 is heat treated at a temperature of about 850° C. or higher and thereby eliminates a processing step. Other characteristics of this TDPS are its (i) low carbon content (42 wt %), (ii) electrically insulating character and (iii) decomposition temperature (500-600° C.). Using ZIF as a thermally decomposable porous support (TDPS) with a non-precious metal precursor (NPMP) and an organic coating/filling compound (OCFC) in the catalyst precursor allows the catalyst to overcome the mass-transport limitations previously experienced with M/N/C-catalysts made using porous supports that do not thermally decompose in an inert atmosphere, such as carbon blacks, furnace blacks, activated carbons, ordered mesoporous carbons, graphite, etc.

Covalent organic frameworks (COFs) are another class of porous polymeric materials, consisting of porous, crystalline, covalent bonds that usually have rigid structures, exceptional thermal stabilities (to temperatures up to 600°), and low densities. COFs are porous, and crystalline, and made entirely from light elements (e.g., H, B, C, N, and O) that are known to form strong covalent bonds. They exhibit permanent porosity with specific surface areas surpassing those of well-known zeolites and porous silicates. Typical surface areas are greater than 200 m²/g and typically between about 500 m²/g and 5000 m²/g. A well-known COF synthesis route is a boron condensation reaction, which is a molecular dehydration reaction between boronic acids. In the case of COF-1, three boronic acid molecules converge to form a planar six-membered B₃O₃ (boroxine) ring with the elimination of three water molecules. Another class of high performance polymer frameworks with regular porosity and high surface area is based on triazine materials which can be achieved by dynamic trimerization reaction of aromatic nitriles in ionothermal conditions (molten zinc chloride at high temperature (400°)). CTF-1 is a good example of this chemistry. Another class of COFs can be obtained by imine condensation of aniline with benzaldehyde that results in imine bond formation with elimination of water. COF-300 is an example of this type of COF.

A microporous polymer is an organic polymer material containing pores with diameters less than 2 nm, which can be used as the thermally decomposable porous structure. Such polymers may include polymers of intrinsic microporosity (PIMs) or hypercrosslinked polymers (HCPs). Some examples may be found in the following paper and in the references within, which is incorporated in its entirety by reference. (M. G. Schwab, J. Am. Chem. Soc., 2009, 131, 7216). Microporous polymers can vary in degree of order and can be amorphous. Microporous polymers typically have a surface area of about 1000-2000 m²/g.

As noted above, the catalyst precursors include a non-precious metal precursor (NPMP). A mixture of NPMPs can be used. Any NPMP known to the skilled person to be useful in catalysts of the prior art (e.g., those produced by adsorption or impregnation) may be used.

Examples of non-precious metals include metals having atomic numbers between 22 and 32, between 40 and 50 or between 72 and 82, with the exclusion of atomic numbers 44-47 and 75-79. In one or more embodiments, the non-precious metal is iron, cobalt, copper, chromium, manganese or nickel. In one or more embodiments, the non-precious metal is iron or cobalt.

In one or more embodiments, the NPMP (iron(II) acetate) makes up about 3 wt % of the catalyst precursor and typically is in the range of 0.6 and 6.0 wt %. Depending on the amount of non-precious metal present in the NPMP, the catalyst precursor comprises between about 0.05 and about 5.0 wt % of the non-precious metal. In one or more embodiments, the catalyst precursor has a non-precious metal content, as provided by the NPMP, of about 0.2, 0.5, 1.0, 2.5, 3.0, 3.5, 4.0, or 4.5 wt % or more. In one or more embodiments, the catalyst precursor has an iron loading of about 0.2 wt % or more based on the total weight of the catalyst precursor. In more specific embodiments, the catalyst precursor has an iron loading of about 1 wt % based on the total weight of the catalyst precursor. Note that the wt % of the non-precious metal is lower in the catalyst precursor than in the final catalyst due to weight loss of the volatile compounds during heat treatment.

As used herein, a “non-precious metal precursor” or NPMP is a molecule that provides a non-precious metal ion to the catalyst during pyrolysis. A NPMP may contain only one non-precious metal ion or a mixture of several non-precious metal ions. As noted above, the active sites of the catalyst comprise at least one non-precious metal ion.

The NPMP may be organometallic or inorganic. The NPMP may be a salt of the non-precious metal or an organometallic complex of the non-precious metal. Non-limiting examples of NPMPs include the following broad classes (with more specific examples in each class given between parentheses): metal acetates and acetylacetonates (Fe(II) acetylacetonate, iron acetate, cobalt acetate, copper acetate, chromium acetate, manganese acetate, nickel acetate); metal sulfates (Fe(II) sulfate); metal chlorides (Fe(II) chloride); metal nitrates (Fe(II) nitrate); metal oxalates (Fe(II) oxalate); metal citrates (Fe(II) citrate); Fe(II) ethylene diammonium sulfate; metal porphyrins (Fe tetramethoxyphenylporphyrin, Fe 4-hydroxy-phenyl porphyrin, mesotetra-phenyl Fe porphyrin, octaethyl Fe porphyrin, Fe pentafluorophenyl porphyrin); metallocenes (ferrocene, cobaltocene); metal-phthalocyanines (cobalt phthalocyanine, iron phthalocyanine); tetra-aza-annulenes (cobalt tetra-aza-annulene); metal oxides; metal nitrides; metal carbides; metal hydroxides (iron hydroxide); metal sputtered over the microporous support; and mixtures of the above.

Other non-limiting examples of NPMPs include cobalt porphyrins, such as Co tetramethoxyphenylporphyrin (TMPP); Fe tetramethoxyphenylporphyrin (TMPP) on pyrolysed perylene tetracarboxylicdianhydride (PTCDA); Fe phthalocyanines; (K₃Fe(CN)₆); Fe and Co tetraphenylporphyrin; Co phthalocyanines; Mo tetraphenylporphyrin; metal/poly-o-phenylenediamine on carbon black; metal porphyrin; molybdenum nitride; cobalt ethylene diamine; hexacyanometallates; pyrrol, polyacrylonitrile and cobalt; cobalt tetraazaannulene; and cobalt organic complexes.

In one or more embodiments, the NPMPs may also be a nitrogen precursor.

As noted above, the catalyst precursors include an organic compound, which is referred to as an organic coating/filling compound (OCFC). Other components in the catalyst precursor may also be organic. A mixture of OCFCs also can be used. The NPMP may be the OCFC, e.g., the NPMP and the OCFC may be the same molecule (in which case the molecule can be an organometallic molecule).

OCFCs (nitrogen-containing or not) are used to coat and/or fill the pores of TDPS particles. The OCFC is carbon-based (e.g., organic) so that it can react with the TDPS to become the building blocks of catalytic sites. As will be appreciated by the person of skill in the art, the exact nature of the OCFC has therefore little importance to the present catalysts as long as the OCFC fulfills the above-noted requirements and roles.

In one or more embodiments, the OCFC may comprise a poly-aromatic structure, i.e., a structure made of rings (formed by a series of connected carbon atoms), preferably aryl rings such as C6 rings, for example benzene. These rings may more easily construct active sites and extend the graphitic platelets (if present) that are found on the edge of the graphitic crystallites (if present) within the microporous carbon support formed during pyrolysis to provide the desired carbon poly-aromatic structure in the micropores of the catalyst.

Different types of OCFC may be used. A first type comprises molecules that contain carbon, but that do not contain nitrogen atoms. Non-limiting examples of classes of such OCFCs include polycyclic aromatic hydrocarbons or their derivatives. Non-limiting examples of OCFCs in these classes include perylene and perylene tetracarboxylic dianhydride.

A second type of OCFC comprises molecules that contain both carbon and nitrogen atoms in their structure. Non-limiting examples of classes of such OCFCs include phenanthrolines, melamine and cyanuric acid.

A further type of OCFC comprises molecules that contain carbon, nitrogen atoms and at least one metal atom in their molecular structure. Non-limiting examples of classes of such OCFCs include metal-phenanthroline complexes, metal-phthalocyanines, and metal-porphyrins.

The OCFC may be any combination of OCFCs from the first, second and/or third above-described types of OCFCs.

In one or more embodiments, the OCFC may be a nitrogen precursor. Non-limiting examples of OCFC that also are nitrogen precursors include the following broad classes (with specific examples given between parenthesis): phenanthrolines (1,10-phenanthroline, bathophenanthroline disulfonic acid disodium salt hydrate, 4,7-diphenyl and 5,6-dimethyl phenanthroline, 4-aminophenanthroline); phthalocyanines; porphyrines; pyrazines (tetra 2 pyridinyl pyrazine, dihydropyridylpyridazine); phthalonitriles (4-amino-phthalonitrile); pyridines (2,2′:6′,2″-terpyridine, 4′-(4-methylphenyl)-2,2′:6′,2″-terpyridine, 6,6″-dibromo-2,2′:6′,2″-terpyridine, 6″-dibromo-2,2′:6′,2″-terpyridine, aminopyridines); melamines; tetra-aza-annulenes; hexaazatriphenylene; tetracarbonitrile; benzene-1,2,4,5-tetracarbonitrile; 6-pyridin-2-yl-[1,3,5]triazine-2,4-diamine; amino-acids; polypyrrole; and polyaniline.

Non-limiting examples of OCFCs that do not contain nitrogen atoms and are thus not nitrogen precursors include the following broad classes (with specific examples given between parenthesis): perylenes (perylene-tetracarboxylic-dianhydride (PTCDA)); cyclohexane; benzene; toluene; pentacene; coronene; graphite transformed into disordered carbon of size<2 nm by ballmilling; polycyclic aromatics (including perylene, pentacene, coronene, etc.); and coal tar or petroleum pitch (these are raw materials for a commercial process for carbon fiber production and are high in polycyclic aromatics).

In one or more embodiments, the OCFC is perylene tetracarboxylic-dianhydride, 1,10-phenanthroline, perylene tetracarboxylic diimide, or polyacrylonitrile or mixtures thereof. Some examples are nitrogen-containing, such as 1,10-phenanthroline, tetra-cyanobenzene; some examples are non-nitrogen containing such as PTCDA, carbon black, graphite; conductive polymers: polypyrrole, polyaniline; phenolic resin, and ionic liquids (1-ethyl-3-methylimidazolium dicyanamide).

To form the catalyst precursor, OCFCs (nitrogen-containing or not) and a NPMP that is a source of a non-precious metal catalyst are mixed to coat and/or fill the pores of the TDPS using some form of mechanical mixing. While mixing may result in the filling of some or all of the pores in the TDPS, it is not absolutely necessary to fill the micropores. Coating part of the TDPS is sufficient. During the pyrolysis of the catalyst precursor, the TDPS, the OCFC and the NPMP decompose (mass loss>60%) to form a unique structure that contains a very high density of catalytic sites inside its micropores and excellent mass transport properties.

The mass ratio of OCFC to TDPS prior to heat treatment can range from 95:5 OCFC:TDPS to about 5:95 OCFC:TDPS by weight. In one or more embodiments, the load of OCFC is 50% or less by weight. In one or more embodiments, the load of OCFC is about 10 wt % to about 40 wt %. In one or more embodiments, the mass ratio of OCFC to TDPS is about 40:60, about 30:70, about 25:75: about 20:80 or 15:85.

Three components, namely at least one thermally decomposable porous support (TDPS), at least one non-precious metal precursor (NPMP) and optional (none, one or more) organic coating/filling compound (OCFC) are mixed together by planetary ball milling or other mixing techniques to obtain a catalyst precursor that is subsequently pyrolyzed in an inert atmosphere such as nitrogen or argon or in a reactive atmosphere such as, NH %, CO₂ or H₂, depending on the choice of the NPMP and/or of the OCFC used. When argon is chosen as a gas during the pyrolysis, it is possible to further improve the catalyst by subjecting it to a second pyrolysis in a reactive gas, such as NH₃ or CO₂, for example. Alternatively, a second treatment other than pyrolysis may be used to achieve a similar effect, such as known methods used to produce activated carbons, for example. See, e.g., Marsh, A & Rodríguez-Reinoso, F (2006). Activation Processes: Thermal or Physical. Activated Carbon (pp. 243-321). Oxford, UK: Elsevier Science] [Marsh, A & Rodríguez-Reinoso, F (2006). Activation Processes: Chemical. Activated Carbon (pp. 322-365). Oxford, UK: Elsevier Science from supplemental material, which is incorporated in its entirety by reference. In some embodiments, the catalyst precursors are subjected to two consecutive pyrolyses: the first in Ar and the second in NH₃. Mixing these three components can also be done by a wet impregnation method.

The TDPS decomposes during the pyrolysis and forms carbon structures that have significantly improved mass transport properties. While not being bound by any particular theory or mode of operation, the improved mass transport properties (over prior M/N/C-catalysts prepared using porous carbon supports that do not thermally decompose in an inert atmosphere, such as carbon black) are observed due to the significant change in carbon structure arising from the decomposition of the catalyst precursor during pyrolysis. When a porous carbon support that does not thermally decompose in an inert atmosphere, such as a microporous carbon black and in particular Black Pearls 2000 which inherently has poor mass transport properties, is used as the microporous support in the catalyst precursor, it remains in large part intact after the pyrolysis and therefore does not result in improved mass transport properties in the catalyst. In contrast, TDPSs undergo a significant mass loss (e.g., greater than about 60% wt) that also gives rise to a significant rearrangement of the structure which forms a microporous and mostly carbonaceous support with improved mass transport performance. In some embodiments, the overall catalyst precursor experiences a mass loss of greater than about 80% by weight, or 75% or 70% of 65% or 60% as compared to the starting mass. In addition, for the resulting catalysts, the decomposition and gasification of the TDPS and the OCFC simultaneously enables results in an even higher concentration of active sites in the catalyst, compared to the M/N/C-catalyst prepared using porous carbon supports that do not thermally decompose in an inert atmosphere. The final result is a non-precious metal catalyst with unprecedented power performance in PEM fuel cell.

The mass loss experienced by the catalyst precursor based on TDPSs decomposition during pyrolysis is very different from that of catalyst precursors based on porous carbon supports that do not thermally decompose in an inert atmosphere, such as carbon blacks and others. For porous carbon supports that do not thermally decompose in an inert atmosphere, the mass loss of the catalyst precursor during pyrolysis to obtain optimal activity was substantially the same as the mass fraction of the OCFC in the catalyst precursor, e.g., the mass loss of the catalyst precursor was due almost exclusively to the decomposition of the OCFC and mass loss of the porous carbon support during pyrolysis was insignificant. Here, for the catalysts based on TDPSs the mass loss leading to the optimal catalytic activity and mass transport properties is far more than simply the mass fraction of OCFC in the catalyst precursor. For example, for a catalyst precursor containing about 20 wt % OCFC, the optimal mass loss during pyrolysis was about 85%. This is the result of the combined decomposition of the TDPS, the OCFC and the NPMP.

When the TDPS, the NPMP and the OCFC are not nitrogen precursors, the necessary nitrogen atoms are provided by a gas used during pyrolysis. Therefore in that case, the gas itself is a nitrogen precursor. The OCFC, the TDPS and the NPMP in the catalyst precursor are believed to react as a whole during pyrolysis to produce the desired catalytic sites in the catalyst. This creation of catalytic sites is different than that in catalysts based on porous carbon supports that do not thermally decompose in an inert atmosphere, such as carbon blacks and others, in that the carbon support and the catalytic sites in the catalyst are formed during the pyrolysis, while the carbon support in catalysts made using porous carbon supports that do not thermally decompose in an inert atmosphere, such as carbon blacks and others, is present in the catalyst precursor and remains throughout the pyrolysis and the final catalyst.

This process has also caused the NPMP and the nitrogen precursor (be it the TDPS, the NPMP, the OCFC or the gas used for pyrolysis) to react and give up some or all of their non-precious metal and nitrogen atoms to the catalytic sites. The active catalytic sites are thus formed from the carbon from the TDPS and/or the OCFC and/or the NPMP, the nitrogen from the TDPS and/or the OCFC and/or the NPMP and/or the pyrolysis gas, and the non-precious metal from the NPMP.

In one or more embodiment, the nitrogen precursor and the NPMP decompose during pyrolysis. The order of decomposition for the TDPS, the NPMP and the OCFC depends on their respective decomposition temperatures and will be different for each combination. In one or more embodiments, that TDPS decomposes last. For example, in one particular catalyst precursor, the NPMP (iron(II) acetate) decomposes first at ca. 190-200° C., followed by the OCFC (1,10-phenanthroline) at ca. 200-300° C. and finally the TDPS (ZIF-8) at ca. 500-600° C. In addition, during decomposition, the TDPS loses mass, gives off gases and/or liquid products and ultimately becomes a highly microporous carbonaceous support as the temperature increases. Therefore, the micropore surface area of the catalyst becomes substantially larger than the catalyst precursor during pyrolysis. In other words, the micropore surface area of the catalyst as described here is substantially larger than the micropore and in particular surface area of the catalyst precursor, which originally had a substantially lower surface area than the TDPS when the OCFC and the NPMP are absent. In the extreme, the micropore surface area of the catalyst may be almost as high as, as high as or higher than the micropore surface area of the TDPS when OCFC and the NPMP were absent.

The non-precious metal content of the catalyst after pyrolysis may be measured by methods known in the art, for example neutron activation analysis.

The catalyst may comprise between about 0.5 to about 10.0 wt % of the nitrogen based on the total weight of the catalyst. In one or more embodiments, the catalyst has a nitrogen content, as provided by the nitrogen precursor, of about 0.5, 1.0, 2.0, 3.0, 4.0, 5.0, 6.0, 7.0, 8.0, or 9.0 wt % or more based on the total weight of the catalyst. This nitrogen content may be measured by methods known in the art, for example, x-ray photoelectron spectroscopy.

If the TDPS is carbon-based, the carbon content in the catalyst is usually about 80 wt % or more based on the total weight of the catalyst. The catalyst may comprise between about 80 and about 99.9 wt % of carbon. It is to be noted that carbon usually comprises some oxygen (usually between 0.5 and 5% wt). If the TDPS has a low carbon content, the carbon content of the catalyst may be lower since the carbon content will be provided primarily only by the OCFC (and optionally the NPMP) used to coat and/or fill the pore of the TDPS.

Catalysts prepared from TDPS-based catalyst precursors enjoy certain advantages. Non-limiting examples include higher catalytic site density, improved mass transport properties and improved operation in fuel cells. First, a higher catalytic site density is achieved, largely due to the high mass loss experienced by the catalyst precursor and in particular the TDPS during the pyrolysis. Secondly, the catalyst has much better mass transport properties, due to its higher permeability to gases and water. Thirdly, the catalyst produced after only one pyrolysis in an inert atmosphere exhibits improved stability in fuel cell operation.

The catalyst precursor may be prepared by the mixing of these three components e.g., the TDPS, the NPMP and the OCFC. At a minimum the catalyst precursor must contain at least one TDPS and at least one NPMP. The catalyst precursor may contain a mixture of two or more species selected from each component category. For example, a catalyst precursor may contain a mixture of MOFs (a TDPS), phenanthroline and PTCDA (OCFCs), iron (II) acetate and cobalt porphyrin (NPMPs).

In one or more embodiments, the catalyst is an oxygen reduction catalyst, a catalyst for the disproportionation of hydrogen peroxide or a catalyst for the reduction of CO₂. H₂O₂ disproportionation reaction has been measured on a catalyst prepared as described herein. The present catalysts can be useful for the disproportionation of hydrogen peroxide and the reduction of CO₂ because it is known for non-precious metal catalysts obtained from heat treatment or without heat treatment (metal-N₄ molecules as phthalocyanines) that the activity for the O₂ electro-reduction reaction and for the chemical disproportionation of H₂O₂ follow the same trend, i.e. if a catalyst shows high activity for one reaction, it will show high activity for the other reaction as well. Further, it is also known that electroreduction of CO₂ is catalyzed by metal macrocycles in which a metal ion is coordinated to 4 nitrogen atoms located in a polyaromatic frame, a structure similar to that proposed for the present catalytic sites used for the reduction of oxygen.

In more specific embodiments, the catalyst is an oxygen reduction catalyst. Such a catalyst will be useful at the cathode of various low temperature fuel cells, including principally polymer electrolyte membrane (PEM) such as H₂/O₂ polymer electrolyte membrane fuel cells, direct alcohol fuel cells, direct formic acid fuel cells and even alkaline fuel cells or microbial fuel cells. Such a catalyst may be useful at the cathode of various primary and secondary metal-air batteries, including zinc-air batteries. In one or more embodiments, the catalyst can serve as a support for precious metal catalyst that are used as conventional catalyst in oxygen reduction reactions.

The M/N/C catalysts may be used at the cathode of PEM, alkaline or microbial fuel cells and in metal-air batteries. With a cathode catalyst loading of 4 mg/cm², power densities comparable to those of Pt-based cathodes are achievable with this catalyst.

### METHOD of Making a M/N/C-Catalyst

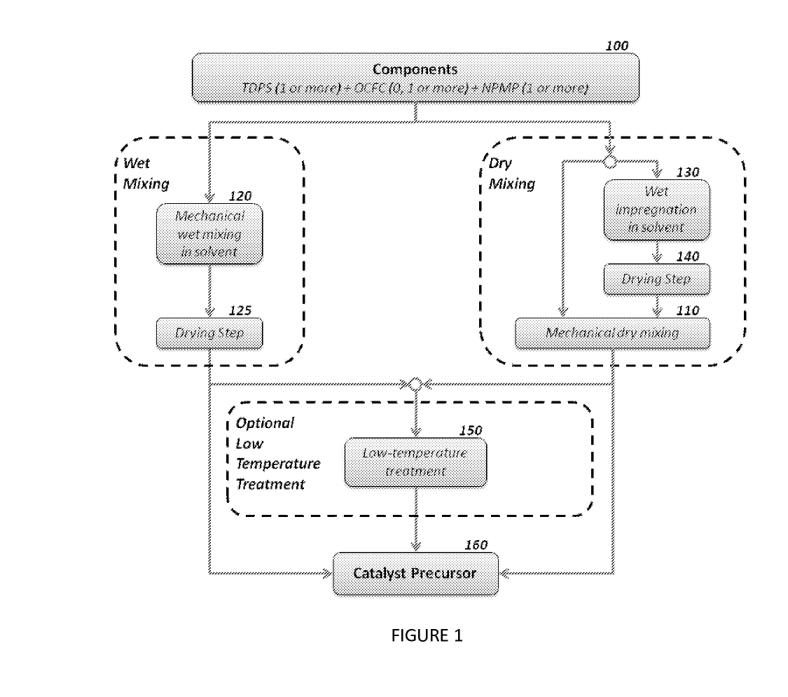

The method of making the catalyst precursor is described with reference to FIG. 1. One or more TDPS (thermally decomposable porous support), one or more NPMP (non-precious metal precursor) and one or more (or no) OCFC (organic coating/filling compound), nitrogen-containing or not, are combined in step 100. The components can be combined dry and then mixed in a mechanical dry mixer as in step 110.

Mechanical mixing refers to mixing involving a milling, grinding or pulverizing system like a planetary ballmiller, high energy ballmiller (sometimes called a shaker mill) or other types such as sonic mixing, freeze mixing, etc. Examples of such methods include any form of ballmilling or reactive ballmilling, including but not limited to planetary ballmilling, and resonant acoustic mixing. Planetary ballmilling is a low-energy material processing technique involving a container with grinding media that rotates in a planet-like motion. It uses both friction and impact effects to thoroughly mix all components and to coat and/or fill the micropores of the TDPS with a mixture of NPMP and OCFC, while leaving some or all of the microstructure of the TDPS relatively unaffected. Resonant acoustic mixing is a method that uses low-frequency high-intensity sound energy for mixing. It may be carried out with or without grinding media. Other forms of mixing are contemplated, so long as it accomplishes the objective of the mixing step which is to form intimate mixture of all the components while dispersing the NPMP and OCFC and coating and/or filling the pores of the microporous support, which is a TDPS. The mechanical mixing may be performed on dry powder mixtures of NPMP, the OCFC and the TDPS (step 110). Alternatively, mechanical mixing may be performed in wet conditions with the NPMP and the OCFC in solution and the TDPS in suspension in this solution as in step 120. In the latter case, the mixture is then dried in step 125 to provide the catalyst precursor 160. In another embodiment, the NPMP and the OCFC in solution and the TDPS in suspension are combined in a solvent (step 130) and then dried (step 140) before being mechanically dry mixed in step 110.

Optionally, prior to becoming a catalyst precursor after mechanical mixing (step 110) or after drying (step 125), a low-temperature treatment (step 150) may be performed. The purpose of the low-temperature treatment is to (i) liquefy the OCFC and/or the NPMP in order to enhance their penetration into the pores TDPS and/or to better disperse the OCFC and/or the NPMP throughout the overall mixture, (ii) to polymerize the OCFC and/or the NPMP, (iii) to complex the OCFC and the NPMP or (iv) to chemically bind the OCFC and/or the NPMP to the TDPS. In one or more embodiments, the reaction time and temperature required for the low-temperature treatment will be easily determined by the person of skill in the art. In one or more embodiments, the low-temperature treatment may be performed at temperatures ranging from about 50° C. to about 500° C.

In one or more embodiments, the micropores of the TDPS are coated and/or filled with the OCFC and the NPMP by mixing, e.g., ballmilling or by resonant acoustic mixing with or without grinding media. In more specific embodiments, the ballmilling is planetary ballmilling.

The NPMP and the OCFC may be introduced into a mixer either together or separately to coat and/or fill the micropores of the TDPS. One or more NPMP, OCFC and/or TDPS can be used in the preparation of the catalyst precursor.

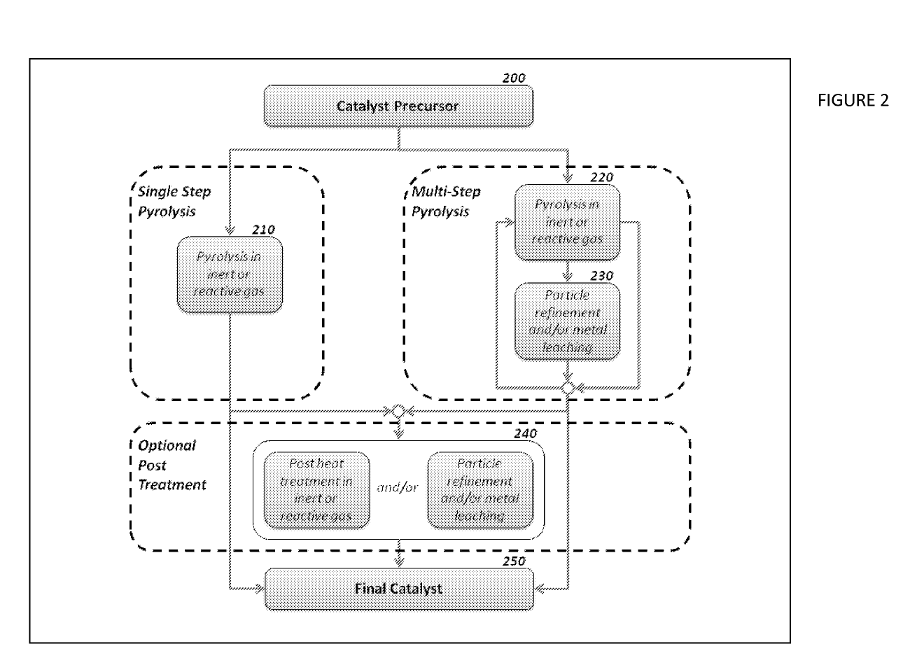

A method of producing a catalyst is described with reference to FIG. 2. The method comprising (A) providing a catalyst precursor comprising one or more TDPSs; one or more NPMPs; and one or more (or no) OCFCs, wherein the micropores of the TDPS are coated and/or filled with the OCFC and/or the NPMP so that the micropore surface area of the catalyst precursor is substantially smaller than the micropore surface area of the TDPS when the OCFC and/or the NPMP are absent (step 200); and (B) pyrolysing the catalyst precursor using either the Single Step Pyrolysis (involving only step 210) or the Multi-Step Pyrolysis (involving steps 220 and optionally 230) so that the micropore surface area of the catalyst is substantially larger than the micropore surface area of catalyst precursor (steps 210-230). Optionally, the method may also comprise (C) an Optional Post Treatment (step 240).

For either the Single Step Pyrolysis or the Multi-Step Pyrolysis the atmosphere in which the pyrolysis is performed may be a nitrogen-containing reactive gas or vapor, non-limiting examples of which being NH₃, HCN, and CH₃CN; a non-nitrogen-containing reactive gas or vapor, non-limiting examples of which being CO₂, H₂O, and air; an inert gas or vapor, non-limiting examples of which being N₂ and Ar; or any mixture of a nitrogen-containing or non-nitrogen containing reactive and an inert gas or vapor.

As used herein a nitrogen-containing reactive gas or vapor is a nitrogen-containing gas or vapor that will react during pyrolysis to provide a nitrogen atom to the catalyst and may also create porosity depending on the gas used. As used herein a non-nitrogen-containing reactive gas or vapor is a non-nitrogen-containing gas or vapor that will create porosity only. As used herein, an inert gas is a gas that will not react with the catalyst precursor/catalyst at the pyrolysis temperature.

The Single Step Pyrolysis involves only one heat treatment step (step 210). If the catalyst precursor (step 200) is nitrogen-containing the pyrolysis may be performed in an inert gas or vapor, a nitrogen-containing reactive gas or vapor or a non-nitrogen-containing gas or vapor. If the catalyst precursor (step 200) does not contain nitrogen the pyrolysis must be performed in a nitrogen-containing reactive gas or vapor.

The Multi-Step Pyrolysis involves two or more cycles of (heat treatment)/(optional particle refinement)/(optional metal leaching). If the catalyst precursor (step 200) is nitrogen-containing, the heat treatment step (step 220) in any cycle within the Multi-Step Pyrolysis may be performed in an inert gas or vapor, a nitrogen-containing reactive gas or vapor or a non-nitrogen-containing gas or vapor. If the catalyst precursor (step 200) is not nitrogen-containing, at least one heat treatment step (step 220) among the two or more cycles within the Multi-Step Pyrolysis must be performed in a nitrogen-containing reactive gas or vapor. Each cycle within the Multi-Step Pyrolysis may contain an optional particle refinement step and/or metal leaching step (step 230).

In steps 210 or 220, the catalyst precursor is heated at temperatures sufficient to pyrolyse the catalyst precursor. The catalyst precursor may be heated to a set temperature using a ramp up with or without intermediate plateaus, or it may be inserted directly into the furnace heating zone at the set temperature. In one or more embodiments, the reaction time and temperature required for the pyrolysis will be easily determined by the person of skill in the art. In one or more embodiments, the pyrolysis may be performed at temperatures ranging from about 300 to about 1200° C. In some embodiments, the pyrolysis is performed at a temperature greater than about 700° C.

After the pyrolysing heat treatment(s) from either the Single Step Pyrolysis (step 210 or the Multi-Step Pyrolysis (two or more cycles of step 220 and optional step 230), the catalyst 250 is obtained.

The Optional Post Treatment (step 240) may be performed to modify or enhance the properties of the catalyst 250. These Optional Post Treatments may involve particle refinement and/or metal leaching and/or a post-heat treatment.

Particle refinement refers to the process by which particle size in a material is reduced. Some non-exhaustive examples of methods used to perform particle refinement include ballmilling and grinding. Ballmilling may be either high-energy (shaker or vibratory mill for example) or low-energy (planetary ball mill or attritor mill for example). Resonant acoustic mixing with grinding media may also be used for particle refinement. Grinding may be performed using a mortar and pestle, or any type of grinding mill that serves to produce fine powders. In step 230 of the Multi-Step Pyrolysis the purpose of particle refinement is to obtain a finer powder for pyrolysis to maximize the reactivity of the powder with the pyrolysis gas. In step 240 of the Optional Post Treatment the purpose of particle refinement is to obtain a finer powder with higher activity and that will produce a smoother and more homogeneous catalyst ink for better performance.

Metal leaching refers to the process by which metal impurities are removed from a material. Some examples of methods used to perform metal leaching are acid-washing and base-washing. Acid-washing may be performed using acid solutions (pH0-pH4, for example) using acids such as H₂SO₄ or HCl, for example. Base-washing may be performed using basic solutions (pH10-pH14, for example) using bases such as KOH or NaOH, for example. Metal leaching may be performed any number of times to achieve the desired result. In particular, when the TDPS is a MOF, for example, it is possible that pyrolysis will leave traces of metals from the source TDPS. This can especially be the case in instances where the MOF includes non-volatile (at the pyrolysis temperature) metals such as cobalt and manganese. In step 230 of the Multi-Step Pyrolysis the purpose of metal leaching is to remove metal impurities originating from the TDPS and/or excess and inactive non-precious metal originating from the NPMP. In step 240 of the Optional Post Treatment the purpose of metal leaching is to remove all excess and inactive metal impurities and unstable catalytic sites.

A post-heat treatment refers to the process by which the catalyst powder undergoes a thermal treatment in an inert or reactive gas or vapor to remove any traces of acid residues in the catalyst powder and/or change the surface functionalities on the surface of the catalyst powder in order to create more or less hydrophilicity or hydrophobicity. In one or more embodiments, the reaction time and temperature required for the post-heat treatment will be easily determined by the person of skill in the art. In one or more embodiments, the post-heat treatment may be performed at temperatures ranging from about 300 to about 1200° C. In one or more embodiments, the post-heat treatment is performed at a temperature greater than about 500° C. In some embodiments, the post-heat treatment gas is H₂.

An advantage of processes using zinc-based MOFs, such as ZIF-8 for example, is that zinc is conveniently removed as a volatile compound during heat treatment of the catalyst precursor containing the zinc-based MOF at a temperature of about 850° C. or higher, depending on the MOF. Samples prepared using ZIF microporous structures, and ZIF-8 in particular contained about 0.5 wt % zinc after pyrolysis. Acid-washing reduced that number down to 0 wt %.

For use in a fuel cell, the catalyst is processed in order to form part of the cathode of the fuel cell. This is typically accomplished by thoroughly mixing the catalyst and an ionomer like Nafion®. The ionomer-to-catalyst mass ratio has to be adjusted and depends on the catalyst, but can be easily determined by the person of skill in the art. The optimal ionomer-to-catalyst mass ratio may range between about 0.5 and about 4. The current density of the fuel cell may be increased by increasing the loading of the catalyst. Therefore, the loading of present catalysts may be increased as long as mass transport losses are acceptable.

If the electronic conductive properties of the obtained catalysts are not sufficient for optimal performance in fuel cell, a given ratio of a conductive powder, e.g., carbon black or any electronic conductive powder that does not corrode in acid medium (for all PEM fuel cells) or alkaline medium (for alkaline fuel cell), may be added.

Other objects, advantages and features will become more apparent upon reading of the following non-restrictive description of specific embodiments thereof, given by way of example only with reference to the accompanying drawings.

### EXAMPLES

### Example 1

### Synthesis of Comparative Electrocatalyst

A comparative electrocatalyst was prepared as described in Lefevre et al. [Science 324 71 (2009)]. Briefly, a mixture of carbon support (Black Pearls 2000), organic compound (1,10-phenanthroline) and iron precursor (ferrous acetate) having a carbon support/organic compound mass ratio of 50/50 and an iron content of 1 wt % was ball milled to form a catalyst precursor. The ball milled mixture was first pyrolysed in argon gas at 1050° C. for 60 minutes, then in ammonia at 950° C. for a time corresponding to a combined mass loss of ca. 50% for both pyrolyses. The resulting powder was the catalyst.

### Example 2

### Synthesis of an M/N/C-Electrocatalyst

Briefly, a mixture of thermally decomposable porous support (TDPS), ZIF-8, an organic coating/filling compound (OCFC), 1,10-phenanthroline, and a non-precious metal precursor (ferrous acetate) having a TDPS/OCFC mass ratio of 80/20 and an iron content of 1 wt % was ball milled to form a catalyst precursor. The ball milled mixture was first pyrolysed in argon gas at 1050° C. for 60 minutes, then in ammonia at 950° C. for a time corresponding to a combined mass loss of ca. 87% for both pyrolyses. The resulting powder was the catalyst.

### Example 3

### Evaluation of Processing Conditions on Catalyst Property

The performance of a cathode catalyst may be assessed by conducting a fuel cell test using a test fuel cell. The test fuel cell used to assess catalysts in embodiments of this invention was a single-MEA test fuel cell. It consisted of a metal end plate, current collector and a graphite gas flow field plate for both anode and cathode sides. It has of an input and output for anode and cathode gases. It includes a means of fastening the test fuel cell tightly together, either using bolts and nuts or using bolts that may be screwed directly into threaded holes in one of the end plates. To assemble a test fuel cell, a membrane electrode assembly (MEA) is placed between the anode and cathode gas flow field plates so that the anode and cathode of the MEA is well positioned and aligned with the gas flow channels of the graphite gas flow field plates. In addition, Teflon gaskets (which also act as spacers) having a cut-out exactly matching and aligning with the shape and size of the anode and cathode of the MEA are placed on either side of the MEA. These gaskets serve to prevent any gas leakage on either side of the fuel cell once it is tightly fastened together, while at the same time controlling the compression exerted directly on the active area of the MEA, i.e. the area defined by the electrodes, to allow a good balance between electrical contact and permeability to gases. The MEA is prepared by hot-pressing an anode and cathode gas diffusion electrode (GDE), consisting of a gas diffusion layer (GDL) coated with a catalyst ink and dried, to either side of a proton exchange membrane (PEM). The catalyst ink is prepared by mixing the catalyst with an ionomer solution and solvents. The catalyst ink may be applied to the GDL using one of many methods, such spray coating, the doctor blade method or simply dropping the ink directly over the GDL and letting it dry, as is the case for embodiments of this invention.

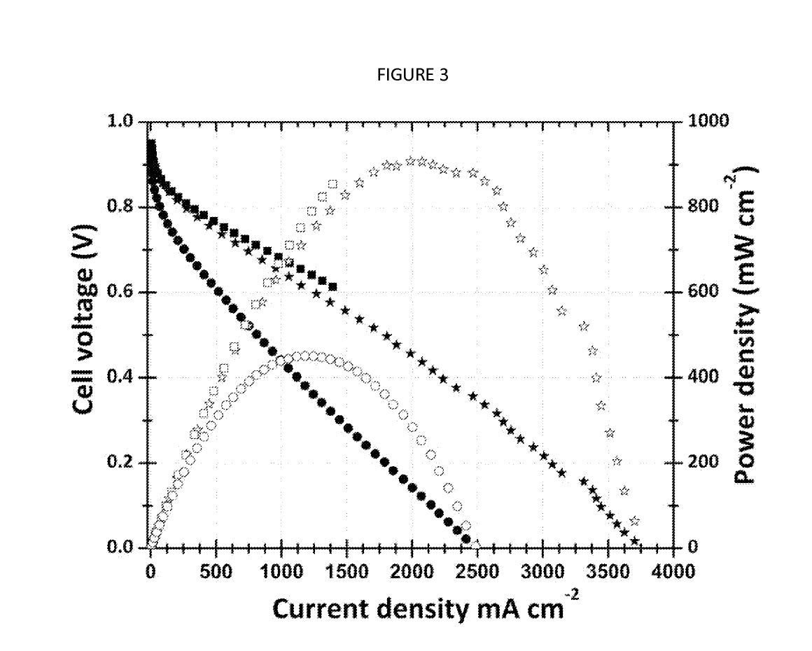

The polarization and power density curves of a membrane electrode assembly (MEA) having a cathode made with a catalyst prepared as in Example 2 (stars), a MEA having a cathode made with a catalyst as prepared in Example 1 (previously most active iron-based catalyst) (circles), and a commercial Pt-based MEA (Gore 5510 PRIMEA, squares) are shown in FIG. 3. All fuel cell tests were conducted under the same conditions: H₂/O₂, 80° C. fuel cell temperature, 15 psig back pressure at the anode and cathode sides, H₂ and O₂ gas flow rates of 0.3 slpm and 100% RH. For the MEAs made with NPMC-based cathodes, the cathode catalyst loading used was ca. 4 mg cm⁻² and the ionomer-to-catalyst ratio was 1.5, the anode GDE was 0.5 mg_{Pt} cm⁻² 46 wt % Pt/C, and the polymer electrolyte membrane used was NRE211. The platinum loading at the cathode of the Gore 5510 PRIMEA MEA was 0.4 mg cm⁻². At 0.6 V cell voltage the MEA having a cathode made with a catalyst of Example 2 exhibits a near 2.4-fold increase in current density (1.25 vs. 0.53 Acm⁻²) and power density (0.75 vs. 0.32 Wcm⁻²) compared to the MEA made with the previously most active iron-based catalyst of Example 1. This brings catalyst performance for non-precious metal catalysts much closer to the power performance of a state-of-the-art commercial Pt-based cathode (Gore 5510 PRIMEA, squares), which produced ca. 0.9 Wcm⁻² under the same fuel cell operating conditions. Furthermore, the peak power density was doubled to 0.91 Wcm⁻² compared to 0.45 Wcm⁻² and the peak power voltage was also increased from 0.37 to 0.45 V for the MEAs prepared using the electrocatalyst of Example 2 and Example 1, respectively.

To help in the understanding of the factors contributing to improved power performance measured in PEMFC, a number of chemical and physical characterizations were conducted on selected catalysts, which included nitrogen adsorption/desorption isotherms (BET surface area and porosimetry using QSDFT), x-ray photoelectron spectroscopy (XPS), neutron activation analysis (NAA), thermo-gravimetric analysis (TGA), powder x-ray diffraction (XRD), scanning electron microscopy (SEM) and transmission electron microscopy (TEM). The effect of (i) a single pyrolysis in argon and (ii) two pyrolyses; the first in argon and the second in ammonia on a catalyst precursor having a ZIF-8/1,10-phenanthroline/Fe mass ratio of 80/20/1 were compared.

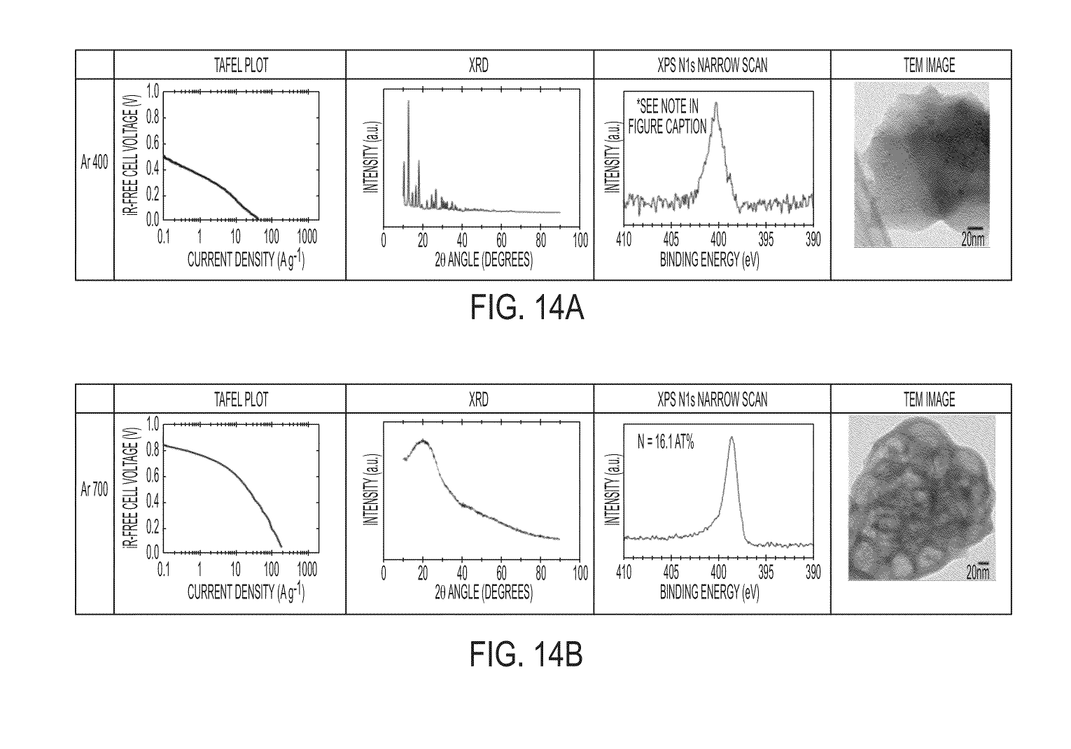

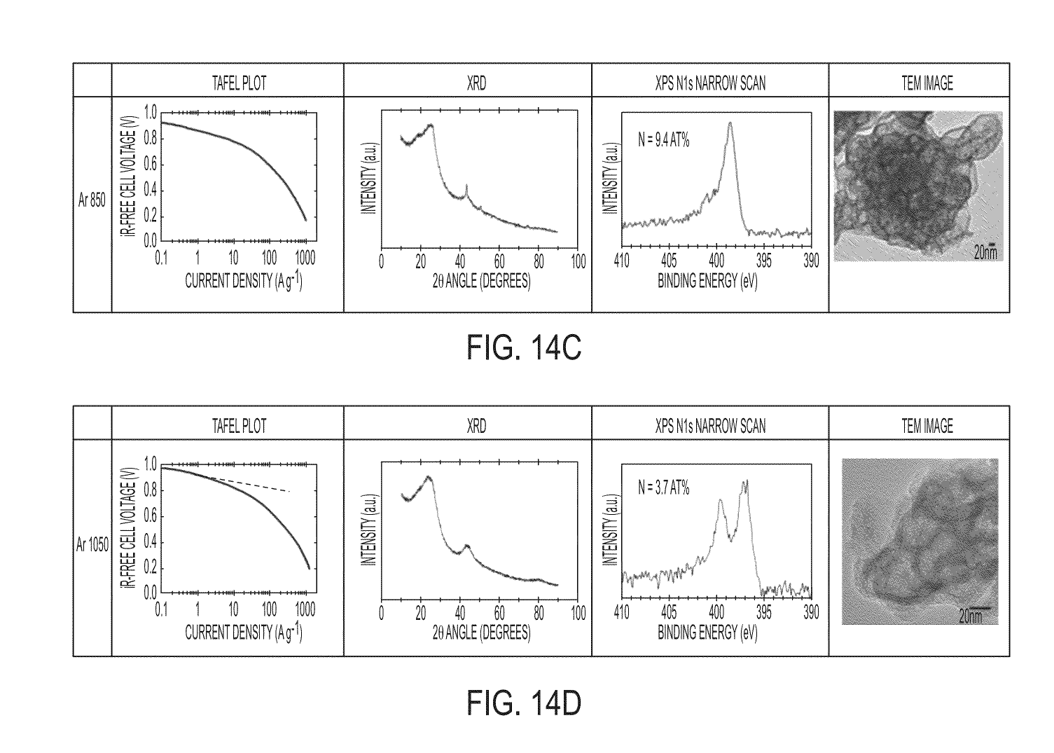

Initial study was conducted to evaluate the effect of different pyrolysis temperatures on the catalyst. The Tafel plots, XRD, XPS N1s narrow scan and TEM images for catalyst precursors heated in argon at 400° C. (A), 700° C. (B), 850° C. (C) and 1050° C. (D) for one hour are shown on FIG. 14A-D and performance results are summarized in Table 1. For catalysts made using a single pyrolysis in argon at various temperatures (400, 700, 850 and 1050° C.) for 1 hour, it was found that 1050° C. produced the most active catalyst with a kinetic current of 1.8 Ag⁻¹ at 0.9 V iR-free cell voltage (see FIG. 14D). This catalyst, however, exhibited poor mass transport, as evidenced by the low current density at lower voltage (see FIG. 14D and Table 1). Ar-pyrolysed-1050° C. achieved a catalytic activity comparable (within a factor of 2-3) to that of the previously reported iron-based catalyst prepared using a carbon black support, but without the need for a second pyrolysis in ammonia, which was previously an essential step for achieving high catalytic activity.

TABLE 1

| | Porous | Organic | Iron | | | |
|---|---|---|---|---|---|---|
| | Support | Compound | Precursor | | | |
| | Used in | Used in | Used in | | | |
| | Catalyst | Catalyst | Catalyst | Gas for | Gas for | N |
| | Precursor | Precursor | Precursor | Pyrolysis #1 | Pyrolysis #2 | Content |
| Catalyst | (wt %) | (wt %) | (wt % Fe) | (1050° C.) | (950° C.) | (at %) |
| Ar-pyrolysed 400° C. | ZIF-8 | 1,10- | FeAc | Ar | — | N/A |
| only | | phenanthroline | (1 wt %) | | | |
| Ar-pyrolysed 700° C. | ZIF-8 | 1,10- | FeAc | Ar | — | 16.1 |
| only | | phenanthroline | (1 wt %) | | | |
| Ar-pyrolysed 850° C. | ZIF-8 | 1,10- | FeAc | Ar | — | 9.4 |
| only | | phenanthroline | (1 wt %) | | | |
| Ar-pyrolysed 1050° C. | ZIF-8 | 1,10- | FeAc | Ar | — | 3.7 |
| only | | phenanthroline | (1 wt %) | | | |
| Ar + NH3-pyrolysed | ZIF-8 | 1,10- | FeAc | Ar | NH₃ | 5.3 |
| | | phenanthroline | (1 wt %) | | | |
| Example 1 | Black | 1,10- | FeAc | Ar | NH₃ | 2.4 |
| | Pearls | phenanthroline | (1 wt %) | | | |
| | 2000 | | | | | |

| | | | Total | Catalytic | BET | Micropore | Mesopore |
|---|---|---|---|---|---|---|---|
| | Fe | Zn | Mass | Activity at | Surface | Surface | Surface |
| | Content | Content | Loss | 0.8 V_{st free} | Area | Area | Area |
| Catalyst | (at %) | (at %) | (%) | (A-g¹) | (m²g¹) | (m²g¹) | (m²g¹) |
| Ar-pyrolysed 400° C. | 0.26 | 5.94 | 12.5 | 0.002 | 1237 | N/A | N/A |
| only | | | | | | | |
| Ar-pyrolysed 700° C. | 0.32 | 6.71 | 29.8 | 0.4 | 106 | 0 | 57 |
| only | | | | | | | |
| Ar-pyrolysed 850° C. | 0.38 | 2.48 | 55.0 | 10 | 273 | 209 | 94 |
| only | | | | | | | |
| Ar-pyrolysed 1050° C. | 0.65 | 0.06 | 69.9 | 283 | 478 | 504 | 46 |
| only | | | | | | | |
| Ar + NH3-pyrolysed | 0.78 | 0.01 | 87 | 1250 | 964 | 814 | 184 |
| Example 1 | 0.44 | 0 | 50 | 429 | 767 | 605 | 162 |

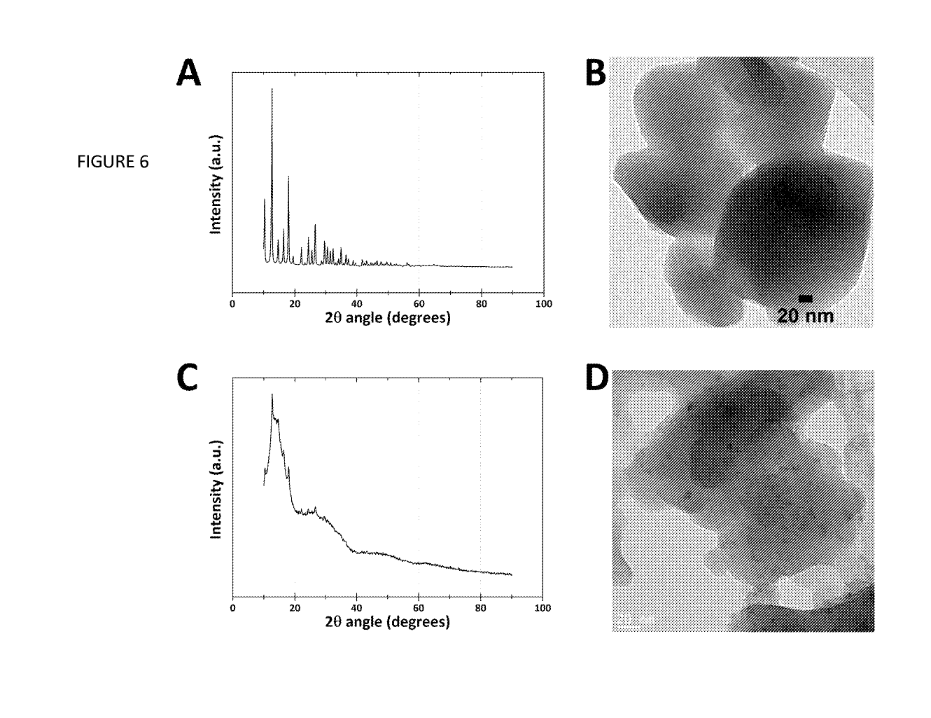

Physical and chemical characterization of the catalyst precursor (i.e. the ball milled mixture prior to pyrolysis) and the four catalysts pyrolysed at four different temperatures in Ar (FIGS. 14A-14D and first four entries in Table 1) revealed that; (i) ball milling alters the structure of the ZIF-8 (compare X-ray diffractograms in FIGS. 6A and C and TEM images in FIGS. 6B and D), (ii) a pyrolysis in Ar at 400° C. appears to have an annealing effect on previously deformed ZIF-8 in the catalyst precursor which regains its original structure (compare X-ray diffractogram in FIG. 6C with that of FIG. 14A), (iii) a pyrolysis at 700, 850 or 1050° C. in Ar decomposes ZIF-8 (evidenced from TGA analysis, not shown), but the latter appears to transform into various carbonaceous alveoli-like structures (see TEM images in FIGS. 14B-14D), (iv) the mass loss during pyrolysis increases with increasing pyrolysis temperature (see Table 1), (v) the quantity of nitrogen, in at %, decreases (see Table 1) with increasing pyrolysis temperature, (vi) the zinc content decreases with increasing pyrolysis temperature with only trace amounts left when pyrolysed in Ar at 1050° C. (see Table 1), and (vii) the surface area of micropores (pore size<2 nm) increases with increasing pyrolysis temperature, beyond temperatures high enough for ZIF-8 decomposition (see Table 1).

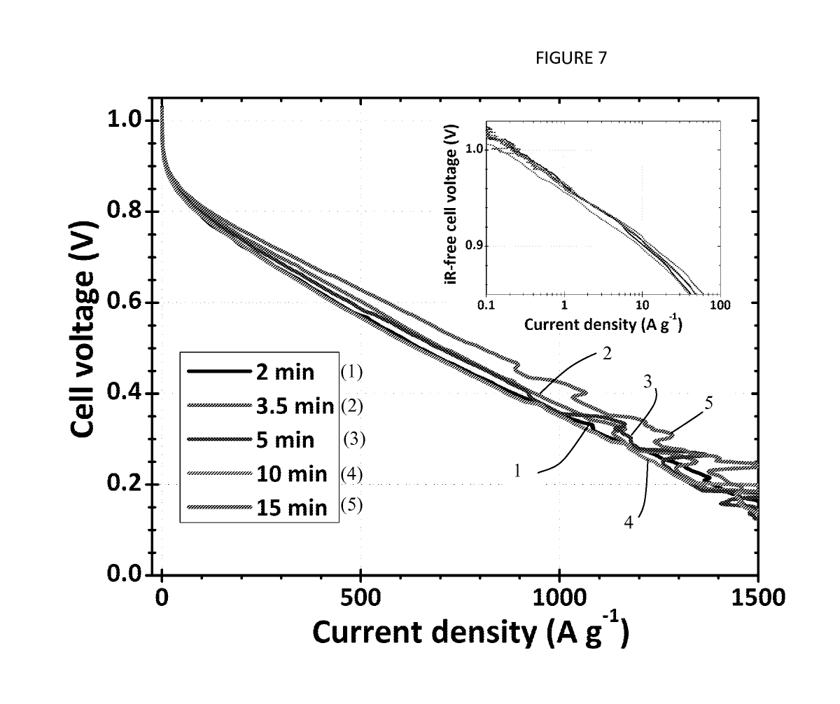

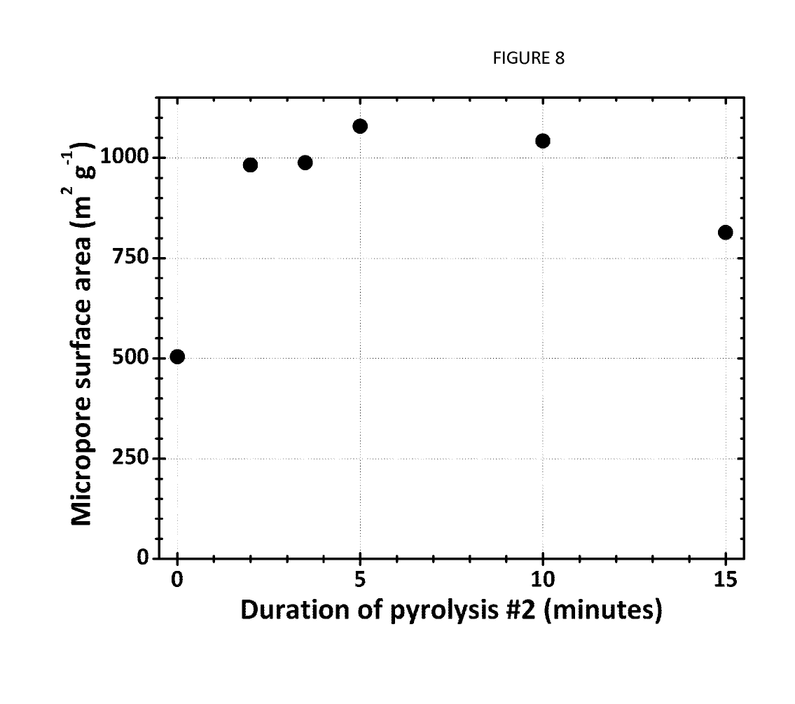

Next, each of the four catalysts shown in FIGS. 14A-14D pyrolysed in Ar for 1 hour underwent a 2nd pyrolysis, this time in NH₃ at 950° C. for two or more different pyrolysis times. Since the catalyst pyrolysed in Ar at 1050° C. resulted in the most active catalyst after a second pyrolysis in ammonia, additional pyrolysis times (2, 3.5, 5, 10 and 15 minutes) were investigated to find an optimum. Among these, the catalyst which resulted in the highest catalytic activity was the one which was first pyrolysed in Ar at 1050° C. for 1 hour, followed by a pyrolysis in ammonia at 950° C. for 15 minutes (see curve 5 in FIG. 7). The mass loss experienced during each pyrolysis for the latter was 67% and 61%, for the first and second pyrolysis, respectively, for an overall mass loss of 87%. The kinetic activity was 16.5 Ag⁻¹ at 0.9V iR-free and 1250 Ag⁻¹ at 0.8V iR-free. The catalytic activity was found to be relatively insensitive (13.0 to 16.5 Ag-1 at 0.9V iR-free) to the mass loss during the pyrolysis in ammonia (24 to 61%), which is consistent with the fact that all these catalysts had about the same micropore (pore size of >2 nm) surface area (814-1079 m²g⁻¹) regardless of the time of pyrolysis, or mass loss during pyrolysis (see FIG. 8).

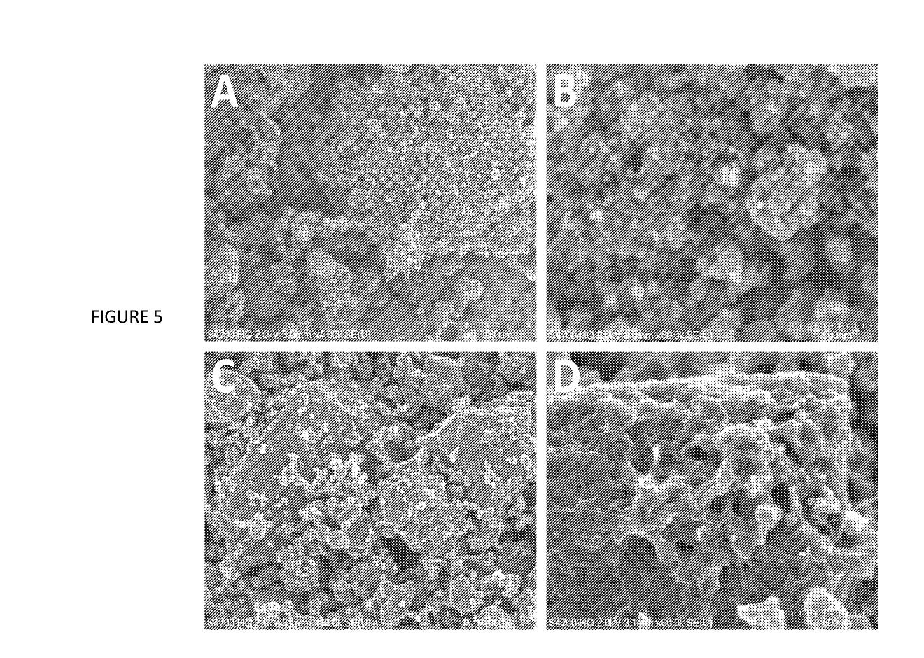

SEM images obtained for the previously most active iron-based catalyst prepared using a carbon black support (FIGS. 5A and B) and a catalyst according to one or more embodiments of the present invention (FIGS. 5C and D), illustrate the difference in morphology between these two catalysts. FIGS. 5A and B show the typical morphology (a compact cauliflower-type) of the previously most active iron-based catalyst prepared using a carbon black support, while FIGS. 5C and D shows the different morphology of a catalyst according to one or more embodiments with seemingly perforated particles having wrinkled surfaces. FIGS. 5C and D suggests that while ZIF-8 particles in the catalyst precursor thermally decompose, many of them do not disintegrate. Instead, the latter are transformed into carbon particles bearing shapes likely similar to the original ZIF-8 particles, but with altered surface and porosity characteristics.

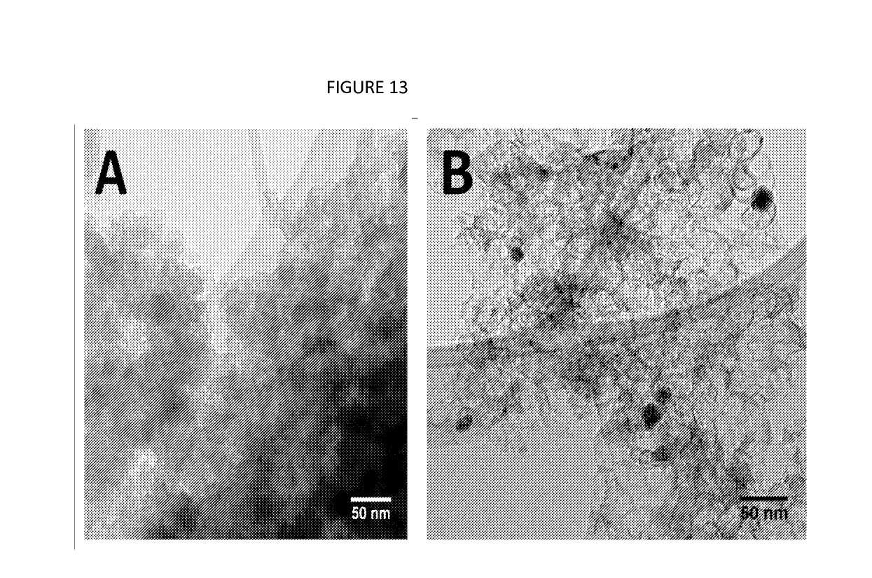

From TEM images one can observe differences in carbon structure, as shown in FIGS. 13A and 13B. While the TEM image of a non-precious metal catalyst (NPMC) from a carbon black support (13A) shows a agglomerated particulate structure, that of a M/N/C catalyst prepared using a thermally decomposable porous support (13B) shows an alveoli-like structure that may be interconnected and have some external openings.”

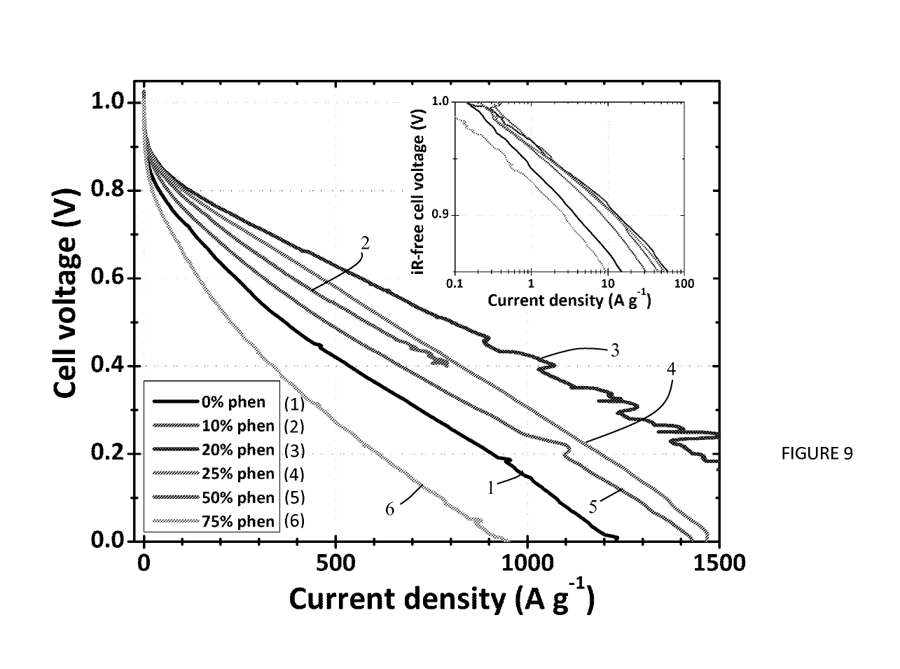

Investigation of the effect of the ZIF-8/1,10-phenanthroline mass ratio (90/10, 80/20, 75/25, 50/50, 75/25) in the catalyst precursor while maintaining the nominal iron content to 1 wt % is shown in FIG. 9. Both the catalytic activity and current density at 0.6V iR-free increased with increasing phenanthroline content to a maximum at 20 wt % (curve in FIG. 9), then gradually decreased with increasing phenanthroline content, with 75 wt % being the worst (see curve 6, FIG. 9). Hence, the optimal ZIF-8/1,10-phenanthroline mass ratio was found to be 80/20 under the stated heat conditions.

Then, using the latter mass ratio, the effect of nominal iron content (0.5, 1.0 and 1.5 wt %) in the catalyst precursor was investigated. The catalytic activities of catalysts made with 0.5 and 1.5 wt % were lower than those made with 1 wt %, although the current densities at 0.6V iR-free were comparable. Hence, the optimal nominal iron content was found to be 1 wt % for this system. Measurements using NAA of the catalyst (ZIF-8/1,10-phenanthroline/Fe mass ratio of 80/20/1, 1^{st} pyrolysis in Ar at 1050° C. for 60 minutes followed by a 2^{nd} pyrolysis in NH₃ at 950° C. for 15 minutes) reveal a catalyst bulk iron content of approximately 3 wt %. When iron was completely omitted from the catalyst precursor the catalytic activity was more than three orders of magnitude lower than the latter, emphasizing the importance of iron.

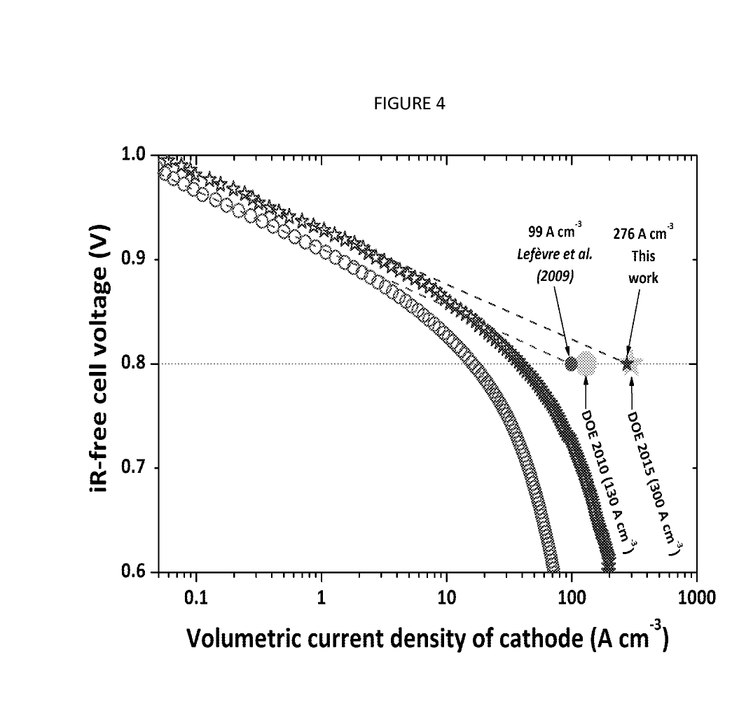

One comparative parameter that is often reported for NPMCs is the volumetric activity for ORR in terms of Acm⁻³_{cathode}. FIG. 4 shows the Tafel plots of an MEA having a cathode made with a catalyst according to one embodiment of the invention (stars) and with the previously most active iron-based catalyst prepared using a carbon black support labelled as Lefevre et al. (2009) (circles). Also shown for reference are the 2010 and 2015 volumetric activity targets for NPMCs for ORR at 0.8V iR-free cell voltage, 130 and 300 Acm⁻³_{cathode} respectively, set by the U.S. DOE. These targets are defined for specific fuel cell operating conditions; they are (i) 80° C. fuel cell operating temperature, (ii) 1 bar absolute pressure for H₂ and O₂ and (iii) 100% RH. Since the volumetric activity target was defined at 0.8V iR-free, a voltage that lies outside of the kinetic region of the Tafel plot, an extrapolation of the Tafel slope is required (dashed lines in FIG. 4). FIG. 4 shows a near threefold increase compared to Lefvre et al. (2009) in volumetric activity to 276 Acm⁻³_{cathode}, very close to the 2015 target.

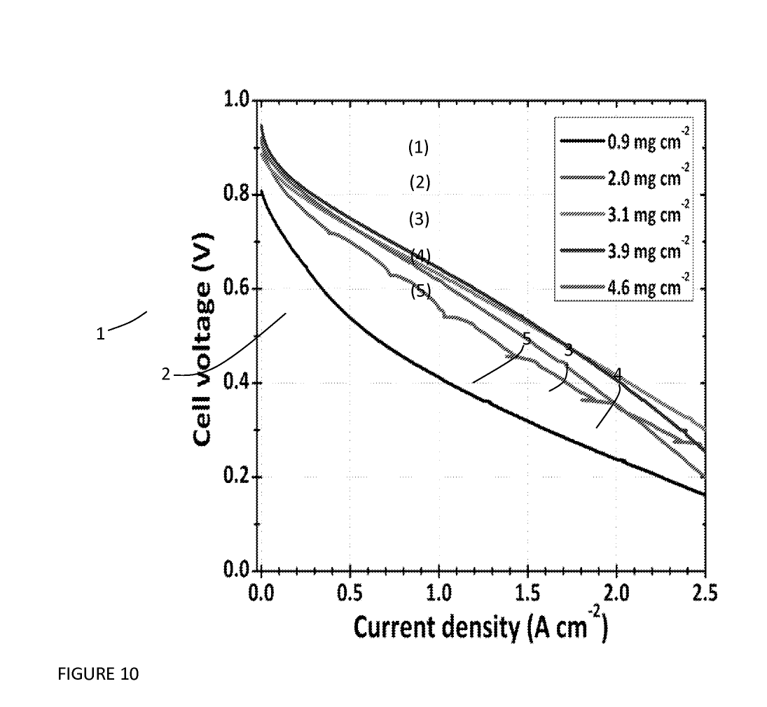

Nafion® NRE211 membranes (˜25 nm thick) were used for fuel cell testing performed with the aim of demonstrating maximum power density at practical fuel cell voltage without iR (voltage drop related to ohmic resistance) correction, by optimizing catalyst loading. Using the latter membranes minimizes protonic resistance and better reflects what is actually used in prototype and commercial H₂/Air fuel cells. Catalyst loadings of roughly 1, 2, 3, 4 and 5 mg cm⁻² were tested. Catalyst loading of approximately 4 mg cm⁻² (curve 4 of FIG. 10) produced the highest current densities at cell voltages between 0.6 and 0.8V (see FIG. 10).

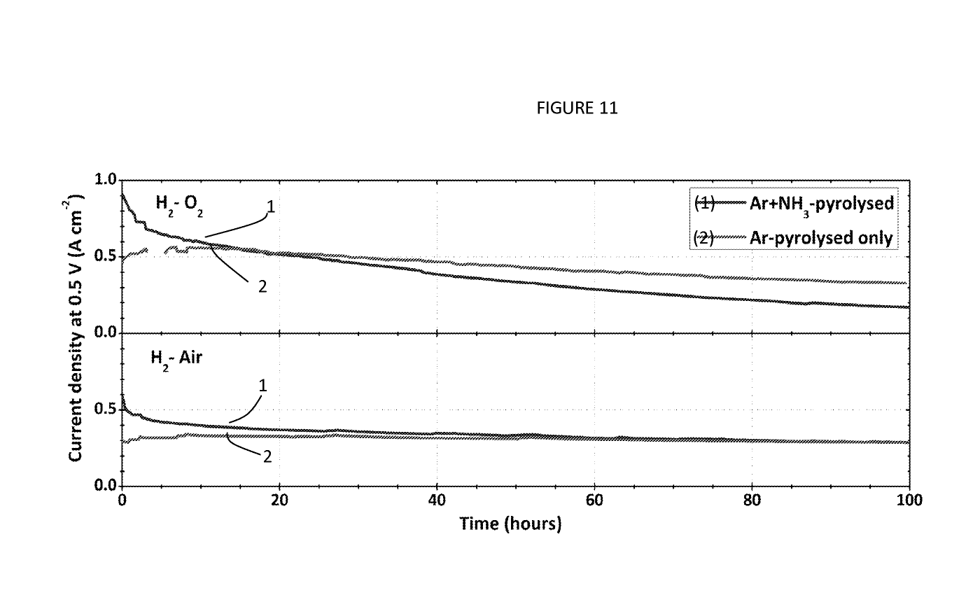

Lastly, 100-hour durability tests in H₂/O₂ and H₂/Air at 0.5 V cell voltage using Nafion® N117 membranes were performed using two catalysts: (i) a catalyst having undergone 2 pyrolyses (ZIF-8/1,10-phenanthroline/Fe mass ratio of 80/20/1, 1^{st} pyrolysis in Ar at 1050° C. for 60 minutes followed by a 2^{nd} pyrolysis in NH₃ at 950° C. for 15 minutes) and (ii) a catalyst having undergone only one pyrolysis (ZIF-8/1,10-phenanthroline/Fe mass ratio of 80/20/1, pyrolysis in Ar at 1050° C. for 60 minutes only). The durability test results in H₂/O₂, presented in FIG. 11, show that the catalyst having undergone 2 pyrolyses as described above undergoes more activity decay than that having undergone a single pyrolysis in Ar. The same observation is true in for durability tests performed in H₂/Air. The best durability performance was by the catalyst having undergone a single pyrolysis in Ar and tested in H₂/Air, which experienced a drop in current density of 15% at 0.5V cell voltage over 100 hours. Lastly, 100-hour durability tests in H₂/Air at 0.5 V cell voltage using Nafion® NRE211 membranes were also performed for a catalyst having undergone a single pyrolysis in Ar followed by acid-washed and reheat-treatment (not shown). Two cycles of acid-washing in a solution of 2:1 H2O:HCl were performed, followed by filtering, rinsing and drying after each cycle. The acid-washed powder was then reheat-treated in Ar at 500° C. for 1 hour to remove acid traces. The latter resulted in improved durability with only an 8% drop in current density.

In summary, iron-based cathodes catalysts for polymer electrolyte membrane fuel cells (PEMFCs) were prepared using a mixture of (i) a thermally decomposable porous support (ZIF-8, a metal-organic framework), (ii) an organic coating/filling compound (1,10-phenanthroline, a small nitrogen-containing organic molecule), and (iii) a non-precious metal precursor (ferrous acetate, an iron compound). The mixture was ball milled, then pyrolysed twice, first in argon at 1050° C., then in ammonia at 950° C. A PEMFC cathode made with the best catalyst in this work produces high power density comparable to commercial platinum-based cathodes at efficient fuel cell voltages (above 0.6 V), with a peak power density of 0.91 watts per square centimeter of cathode. Its volumetric activity of 276 amps per cubic centimeter of cathode is the highest ever reported to date for a non-precious metal catalyst for oxygen reduction in PEMFC and is within grasp of the U.S. DOE's 2015 target of 300 amps per cubic centimeter of cathode.

### Example 4

### Preparation of M/N/C Catalysts

M/N/C Catalysts were prepared using a variety of different OCFC's and NPMP's and using a range of processing conditions.

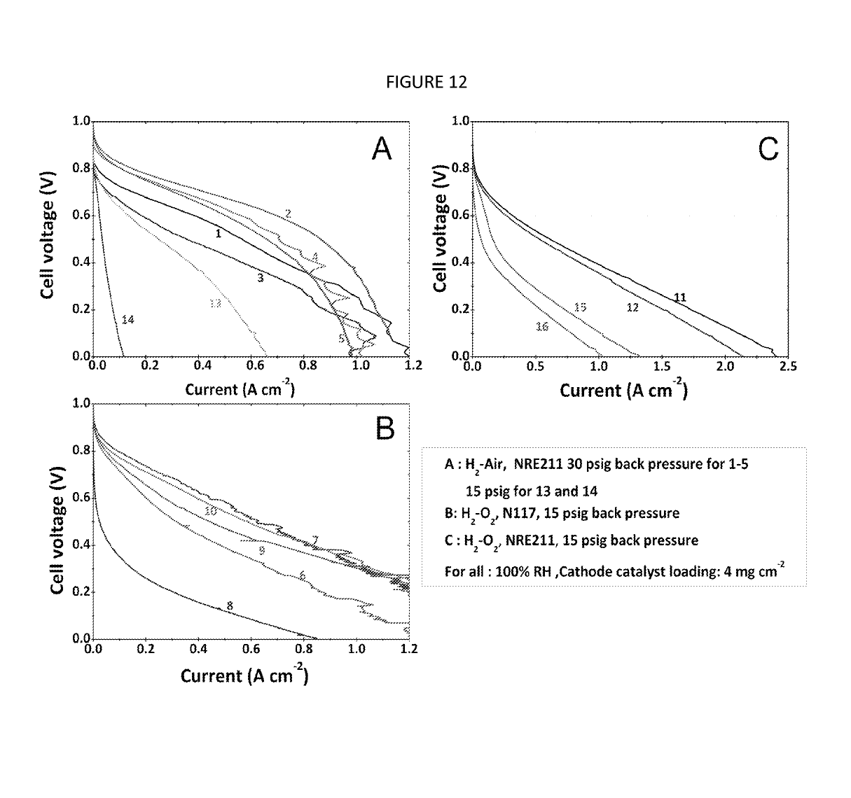

Examples of catalysts were made using the methods described in FIGS. 1 and 2. Polarization curves are shown in FIG. 12. The polarisation curves appearing in the three graphs in FIG. 12 are numbered and details of the methods used to make their respective cathode catalysts are available in the accompanying Table 2. The examples include a catalyst made using the Single Step Method (examples 3, 11-14) and several (all except 3, 11-14) made using the Multi-Step Method. Some catalysts were made using an Optional Post Treatment (examples 3 and 5), some have an acid-washing between two pyrolysis to remove the excess metal coming from the thermally decomposable porous support (examples 15-16) and some were made without (examples 1, 2, 4 and 6-14). Some of the catalysts made using the Multi-Step methods were pyrolysed using NH₃ gas (examples 1, 2, 5-10 and 15-16) and one using CO₂ (example 4). One of the catalyst precursors for the catalysts was prepared using wet impregnation step without ballmilling (example 8), others using ballmilling without a prior wet impregnation step (examples 2, 7 and 12-14) and others using a wet impregnation step and a ballmilling step (examples 1, 3-6, 9-10 and 15-16). The non-precious metal used to make one catalyst was cobalt (example 1) and iron was used for others (examples 2-7 and 9-16). In addition to introducing the metal as the NPMP in the catalyst precursor, the metal can also be introduced via the OCFC (example 13-14) or it can be introduced via the TDPS (example 15-16). The nominal non-precious metal loading in the catalyst precursors of some catalysts was 1 wt % (examples 1-7), while one had 0.5 wt % (example 9), one had 1.5 wt % (example 10), one had 2 wt % (example 13), one had 6.4 wt % (example 14), one had 8 wt % (example 16) and another had 16 wt % (example 15). It is to be noted that one catalyst (example 8) was made with a non-precious metal loading of 0 wt %, to demonstrate the importance of the non-precious metal content in the catalyst precursor for obtaining active catalysts. The organic coating/filling compound (OCFC) used for making some catalysts (examples 1, 3-5 and 8-10) was 1,10-phenanthroline, for others (examples 6 and 7) it was TPTZ, and for another (example 2) it was PTCDA. The OCFC can also be a combination of polymers such as polyacrilonitrile (PAN) and phenanthroline (example 11), or alone like the polyaniline (PANI) (example 12). Other types of MOF can be also be used. Basolite Z1200 is used for example 1-14 and the Basolite F300 is used for examples 15-16. Finally, for some catalysts the mass ratio of OCFC to thermally decomposable porous support was 80/20 (examples 1-5 and 8-10), in others it was 10/90 (examples 6 and 7) and others 50/50 (examples 14 and 16).

TABLE 2
Examples of catalysts made with ZIF-8 as the TDPS and different OCFCs, NPMPs and optional treatments

| | | | | | | | 1^{st} | | |
|---|---|---|---|---|---|---|---|---|---|
| | | | | | | | pyrolysis | 2^{nd} | |
| | | | | | NPM | | Ar | pyrolysis | |
| | | | | | content | Catalyst | 1050° C. | 950° C. | |
| | | | OCFC/TDPS | | in | precursor | 60 | (yes/no) | |
| | | | mass | | catalyst | mixing | minutes | (gas | Optional |
| Sample # | OCFC | TDPS | ratio | NPMP | precursor | method | (yes/no) | used) | Treatment |
| 1 | Phen | ZIF-8 | 20/80 | CoAc | 1 wt % | Impregnation + | yes | Yes | None |
| | | | | | | drying + | | NH₃ | |
| | | | | | | ball milling | | | |
| 2 | PTCD | ZIF-8 | 20/80 | FeAc | 1 wt % | Dry ball | yes | Yes | None |
| | | | | | | milling only | | NH₃ | |
| 3 | Phen | ZIF-8 | 20/80 | FeAc | 1 wt % | Impregnation + | yes | No | Acid-washing (HCl) + |
| | | | | | | drying + | | | post heat treatment at |
| | | | | | | ball milling | | | 500° C. after 1^{st} pyrolysis |
| 4 | Phen | ZIF-8 | 20/80 | FeAc | 1 wt % | Impregnation + | yes | Yes | None |
| | | | | | | drying + | | CO₂ | |
| | | | | | | ball milling | | | |
| 5 | Phen | ZIF-8 | 20/80 | FeAc | 1 wt % | Impregnation + | yes | Yes | Acid-washing (HCl) + |
| | | | | | | drying + | | NH₃ | post heat treatment at |
| | | | | | | ball milling | | | 500° C. after 2^{nd} pyrolysis |
| 6 | TPTZ | ZIF-8 | 10/90 | FeAc | 1 wt % | Impregnation + | yes | yes | None |
| | | | | | | drying + | | NH₃ | |
| | | | | | | ball milling | | | |
| 7 | TPTZ | ZIF-8 | 10/90 | FeAc | 1 wt % | Dry ball | yes | yes | None |
| | | | | | | milling only | | NH₃ | |
| 8 | Phen | ZIF-8 | 20/80 | None | 0 wt % | Impregnation | yes | yes | None |
| | | | | | | only | | NH₃ | |
| 9 | Phen | ZIF-8 | 20/80 | FeAc | 0.5 wt % | Impregnation + | yes | yes | None |
| | | | | | | drying + | | NH₃ | |
| | | | | | | ball milling | | | |
| 10 | Phen | ZIF-8 | 20/80 | FeAc | 1.5 wt % | Impregnation + | yes | yes | None |
| | | | | | | drying + | | NH₃ | |
| | | | | | | ball milling | | | |
| 11 | Phen + | ZIF-8 | 20/20/80 | FeAc | 1 wt % | Impregnation + | yes | No | |
| | PAN | | | | | drying + | | | |
| | | | | | | ball milling | | | |
| 12 | PANI | ZIF-8 | 20/80 | FeAc | 1 wt % | Dry ball | Yes | No | None |
| | | | | | | milling only | | | |
| 13 | FePc | ZIF-8 | 20/80 | — | 2 wt % | Dry ball | Yes | No | None |
| | | | | | | milling only | | | |
| 14 | FePc | ZIF-8 | 50/50 | — | 6.4 wt % | Dry ball | Yes | No | None |
| | | | | | | milling only | | | |
| 15 | Phen | F-300 | 20/80 | — | 16 wt % | Impregnation + | Yes | Yes | Acid-washing after 1^{st} |
| | | | | | | drying + | | NH₃ | pyrolysis |
| | | | | | | ball milling | | | |
| 16 | Phen | F-300 | 50/50 | — | 8 wt % | Impregnation + | Yes | Yes | Acid-washing after 1^{st} |
| | | | | | | drying + | | NH₃ | pyrolysis |
| | | | | | | ball milling | | | |

1. A catalyst precursor, comprising:
a thermally decomposable porous support;
an organic coating/filling compound;
a non-precious metal precursor,
wherein the organic coating/filling compound and the non-precious metal catalyst precursor coat and/or fill the pores of the thermally decomposable porous support.

2. The catalyst precursor of claim 1, wherein at least one of the thermally decomposable porous support, the non-precious metal precursor or the organic coating/filling compound comprises nitrogen.

3. The catalyst precursor of claim 1, wherein the thermally decomposable porous support is microporous and is one or more supports selected from the group consisting of metal-organic-frameworks, covalent-organic-frameworks, polymer-organic-frameworks, microporous organic polymers, polymers of intrinsic microporosity and a microporous polymers.

4. The catalyst precursor of claim 3, wherein the metal organic framework comprises a zeolitic imidazolate framework.

5. The catalyst precursor of claim 4, wherein the zeolitic imidazolate framework comprises ZIF-8.

6. The catalyst precursor of claim 4, wherein the metal of the zeolitic imidazolate framework comprises zinc.

7. The catalyst precursor of claim 3, wherein the thermally decomposable porous support comprises a metal organic framework and the metal is one or more selected from the group consisting of zinc, cobalt, manganese, magnesium, iron, copper, aluminum and chromium.

8. The catalyst precursor of claim 1, wherein the thermally decomposable porous support has a total surface area of greater than 500 m²/g.

9. The catalyst precursor of claim 1, wherein the thermally decomposable porous support has a total surface area of greater than 1000 m²/g.

10. The catalyst precursor of claim 1, wherein the thermally decomposable porous support has a total surface area of greater than 1500 m²/g.

11. The catalyst precursor of claim 1, wherein the thermally decomposable porous support is one that loses between 20% and 90% of its mass in an inert atmosphere at a temperature in the range of 100° C. to 1200° C.

12. The catalyst precursor of claim 1, wherein the thermally decomposable porous support is one that loses at least 50% of its mass in an inert atmosphere at a temperature in the range of 100° C. to 1200° C.

13. The catalyst precursor of claim 1, wherein the non-precious metal precursor is a precursor of iron or cobalt.

14. The catalyst precursor of claim 1, wherein the non-precious metal precursor is a precursor of iron.

15. The catalyst precursor of claim 14 having an iron loading of about 0.2 wt % to about 5 wt % or more based on the total weight of the catalyst precursor.

16. The catalyst precursor of claim 15 having an iron loading of about 1-2 wt % based on the total weight of the catalyst precursor.

17. The catalyst precursor of claim 1, wherein the non-precious metal precursor is a salt of a non-precious metal or an organometallic complex of a non-precious metal.

18. The catalyst precursor of claim 17, wherein the non-precious metal precursor is an iron salt Fe(II) acetate.

19. The catalyst precursor of claim 1, wherein the non-precious metal precursor and the organic coating/filling compound are the same molecule.

20. The catalyst precursor of claim 1, wherein the organic coating/filling compound comprises a poly-aromatic structure.

21. The catalyst precursor of claim 20, wherein the organic coating/filling compound is selected from the group consisting of perylene-tetracarboxylic-dianhydride, 1,10-phenanthroline, perylene tetracarboxylic-diimide, and polypyrrole or polyaniline and mixtures thereof.

22. The catalyst precursor of claim 1, wherein the mass ratio of organic coating/filling compound to thermally decomposable porous support is about 95:5 to about 5:95.

23. A catalyst prepared by pyrolysing the catalyst precursor of claim 1, wherein said catalyst precursor has been pyrolysed so that the micropore surface area of the catalyst is substantially larger than the micropore surface area of catalyst precursor, with the proviso that the pyrolysis is performed in the presence of a gas that is a nitrogen precursor when the thermally decomposable porous support, the non-precious metal precursor and the organic coating/filling compound are not nitrogen precursors.

24. A catalyst of claim 23, wherein the pyrolysis temperature is between 300° C. and 1200° C.

25. A catalyst of claim 24, wherein the pyrolysis temperature is at least 700° C.

26. The catalyst of claim 24, wherein a mass loss during pyrolysis is greater than 50%.

27. The catalyst of claim 26, wherein the mass loss during pyrolysis is greater than 80%.

28. A catalyst comprising:
a microporous carbon support and having a carbon content of at least 80 wt % and a total surface area of at least 500 m²/g; and
a non-precious metal at a loading of at least 0.2 wt %, wherein the non-precious metal-ion is in contact with the microporous support through a pyridinic or pyrrolic-type structure forming the catalytic sites, wherein the catalyst when incorporated into a membrane electrode assembly demonstrates a volumetric activity of greater than 100 A/cm³ at an iR-free cell voltage of 0.8V.

29. The catalyst of claim 23 having a nitrogen content of about 0.5 wt % or more based on the total weight of the catalyst.

30. The catalyst of claim 23, wherein the catalyst is selected from the group consisting of an oxygen reduction catalyst, a catalyst for the electroreduction of hydrogen peroxide, a catalyst for the disproportionation of hydrogen peroxide or a catalyst for the reduction of CO₂.

31. The catalyst of claim 23, wherein the catalyst comprises an oxygen reduction catalyst.
